(19) United States
(12) Patent Application Publication
(10) Pub. No.: US 2022/0127817 A1
(43) Pub. Date: Apr. 28, 2022

(54) EXCAVATOR

(71) Applicant: SUMITOMO HEAVY INDUSTRIES, LTD., Tokyo (JP)

(72) Inventors: Yusuke SANO, Kanagawa (JP); Chunnan WU, Kanagawa (JP); Kazunori HIRANUMA, Kanagawa (JP)

(21) Appl. No.: 17/647,222

(22) Filed: Jan. 6, 2022

Related U.S. Application Data
(63) Continuation of application No. PCT/JP2020/027119, filed on Jul. 10, 2020.

(30) Foreign Application Priority Data
Jul. 11, 2019 (JP) 2019-129524

(51) Int. Cl. E02F 3/43; E02F 9/26

(52) U.S. Cl. CPC E02F 3/437; E02F 9/262; E02F 9/265

(57) ABSTRACT

An excavator includes an attachment attached to a revolving upper body; and a first actuator and a second actuator configured to drive the attachment; and a control device including a memory and a processor configured to execute calculating a weight of a loaded matter loaded in the attachment as a first weight, based on the first actuator, and calculating the weight of the loaded matter as a second weight, based on the second actuator.

### CROSS-REFERENCE TO RELATED APPLICATION

The present application is a continuation application of International Application No. PCT/JP2020/027119 filed on Jul. 10, 2020, which is based on and claims priority to Japanese Patent Application No. 2019-129524, filed on Jul. 11, 2019. The contents of these applications are incorporated herein by reference in their entirety.

### TECHNICAL FIELD

The present disclosure relates to an excavator.

### BACKGROUND

For example, a method of calculating the amount of soil under operation of a hydraulic excavator that includes a front attachment constituted with a link mechanism including a bucket and a boom; and a controller unit that detects a state of a series of operations by this front attachment including excavation, soil releasing, and returning revolution, to measure the load acting on the bucket during these operations within a period of time from the completion of excavation to the start of soil releasing, and to measure the load acting on the bucket again within a period from the end of soil releasing to the start of excavation, so as to calculate the difference between these two loads to calculate the amount of soil under operation during the excavation, has been known.

However, in such a conventional method, although the weight of the earth and sand is estimated based on the pressure of the boom cylinder, during an operation of raising the boom, at a timing of the start of the operation and at a timing of the end of the operation, oscillation may be generated on the estimated waveform of the weight of the earth and sand, and make detection of the weight of the earth and sand difficult.

### SUMMARY

According to one embodiment of the present inventive concept, an excavator includes an attachment attached to a revolving upper body; and a first actuator and a second actuator configured to drive the attachment; and a control device including a memory and a processor configured to execute calculating a weight of a loaded matter loaded in the attachment as a first weight, based on the first actuator, and calculating a weight of the loaded matter as a second weight, based on the second actuator.

### BRIEF DESCRIPTION OF THE DRAWINGS

FIG. 1 is a side view of an excavator according to the present embodiment;

FIG. 2 is a diagram schematically illustrating an example of a configuration of the excavator according to the present embodiment;

FIG. 3 is a diagram schematically illustrating an example of a configuration of a hydraulic system of the excavator according to the present embodiment;

FIG. 4A schematically illustrates an example of components related to an operation system in the hydraulic system of the excavator according to the present embodiment;

FIG. 4B schematically illustrates an example of components related to an operation system in the hydraulic system of the excavator according to the present embodiment;

FIG. 4C schematically illustrates an example of components related to an operation system in the hydraulic system of the excavator according to the present embodiment;

FIG. 5 schematically illustrates an example of components related to a function of detecting a load of earth and sand in the excavator according to the present embodiment;

FIG. 6A is a schematic diagram illustrating parameters related to calculation of the weight of the earth and sand in an attachment of the excavator;

FIG. 6B is a schematic diagram illustrating parameters related to calculation of the weight of the earth and sand in an attachment of the excavator;

FIG. 7A is a partially enlarged view illustrating a relationship of forces acting on a bucket;

FIG. 7B is a partially enlarged view illustrating a relationship of forces acting on a bucket;

FIG. 8 is a schematic diagram illustrating a third method of calculating center of gravity executed by a center of gravity of load calculating part;

FIG. 9 is a schematic diagram illustrating a fourth method of calculating center of gravity executed by a center of gravity of load calculating part;

FIG. 10 is a diagram illustrating an example of a configuration of a main screen displayed on a display device; and

FIG. 11 is a diagram illustrating an example of a configuration of a loading support system.

### DETAILED DESCRIPTION OF EMBODIMENTS

In the following, embodiments for implementing the present inventive concept will be described with reference to the drawings.

According to the embodiment described above, an excavator that precisely calculates the weight of the loaded matter can be provided.

### [Overview of Excavator]

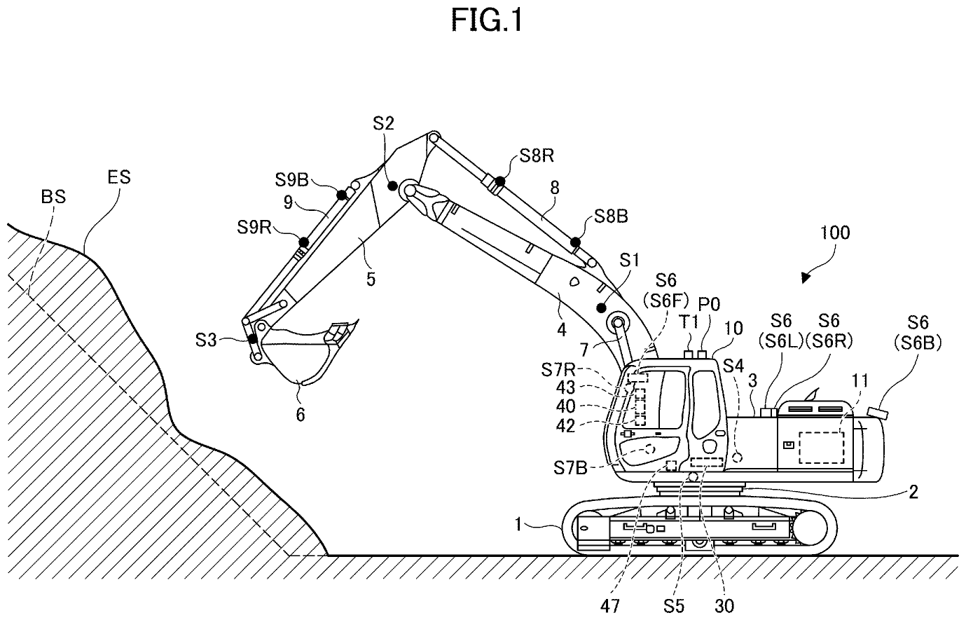

First, with reference to FIG. 1, an overview of an excavator 100 according to the present embodiment will be described.

FIG. 1 is a side view of the excavator 100 as an excavation machine according to the present embodiment.

Note that in FIG. 1, the excavator 100 is positioned on a horizontal surface in front of an upward tilt surface ES to be constructed; and in the figure, an upward slope surface BS (i.e., a shape of a slope surface to be formed after construction is completed on the upward tilt surface ES) is also illustrated as an example of a target construction surface that will be described later. Note that on the upward tilt surface ES to be constructed, a cylindrical body (not illustrated) is provided to indicate a direction normal to the upward slope surface BS as the target construction surface.

The excavator 100 according to the present embodiment is provided with a traveling lower body 1; a revolving upper body 3 mounted on the traveling lower body 1, to be capable of revolving via a revolution mechanism 2; a boom 4, an arm 5, and a bucket 6 constituting an attachment (machinery); and a cabin 10.

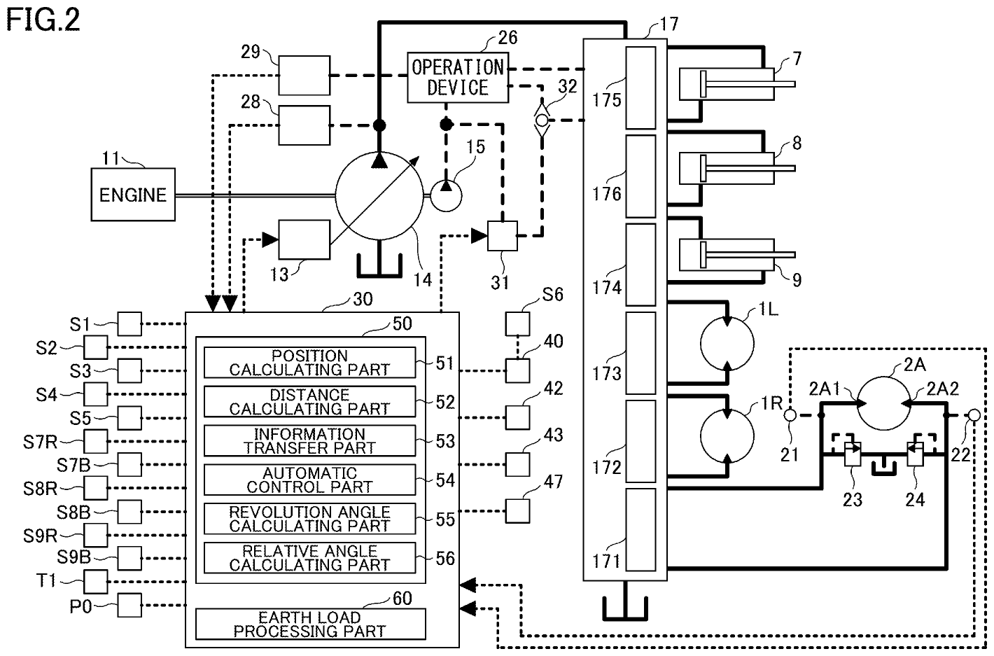

By having a pair of crawlers on the left and right hydraulically driven by hydraulic motors for traveling 1L and 1R (see FIG. 2 that will be described later), the traveling lower body 1 drives the excavator 100. In other words, the pair of hydraulic motors for traveling 1L and 1R (an example of a motor for traveling) drives the traveling lower body 1 (crawlers) as a driven part.

The revolving upper body 3 is driven by a hydraulic motor for revolution 2A (see FIG. 2 that will be described later), and revolves with respect to the traveling lower body 1. In other words, the hydraulic motor for revolution 2A is a revolution driving part to drive the revolving upper body 3 as a driven part, and can change the orientation of the revolving upper body 3.

Note that the revolving upper body 3 may be electrically driven by an electric motor (referred to as the “electric motor for revolution”, hereafter), instead of the hydraulic motor for revolution 2A. In other words, like the hydraulic motor for revolution 2A, the electric motor for revolution is a revolution driving part to drive the revolving upper body 3 as a driven part, and can change the orientation of the revolving upper body 3.

The boom 4 is attached to the center of the front part of the revolving upper body 3, to be capable of being elevated; at the tip of the boom 4, the arm 5 is attached to be capable of rotating upward or downward; and at the tip of the arm 5, the bucket 6 as an end attachment is attached to be capable of rotating upward or downward. The boom 4, the arm 5, and the bucket 6 are hydraulically driven by a boom cylinder 7, an arm cylinder 8, and a bucket cylinder 9 as hydraulic actuators, respectively.

Note that the bucket 6 is an example of an end attachment, and at the tip of the arm 5, instead of the bucket 6, depending on the contents of work, another end attachment, such as a bucket for slope surface, a bucket for dredging, a breaker, or the like may be attached.

The cabin 10 is a cab boarded by the operator, and is mounted on the left side of the front part of the revolving upper body 3.

### [Configuration of Excavator]

Next, with reference to FIG. 2 in addition to FIG. 1, a specific configuration of the excavator 100 according to the present embodiment will be described.

FIG. 2 is a schematic diagram illustrating an example of a configuration of the excavator 100 according to the present embodiment.

Note that in FIG. 2, a mechanical power transmission system, hydraulic oil lines, pilot lines, and an electric control system are designated with double lines, solid lines, dashed lines, and dotted lines, respectively.

The driving system of the excavator 100 according to the present embodiment includes an engine 11, regulators 13, main pumps 14, and control valves 17. Also, as described above, the hydraulic drive system of the excavator 100 according to the present embodiment includes hydraulic actuators including the hydraulic motors for traveling 1L and 1R, the hydraulic motor for revolution 2A, the boom cylinder 7, the arm cylinder 8, and the bucket cylinder 9, for hydraulically driving the traveling lower body 1, the revolving upper body 3, the boom 4, the arm 5, and the bucket 6, respectively.

The engine 11 is the main power source in the hydraulic drive system, and is installed, for example, in the rear part of the revolving upper body 3. Specifically, the engine 11 revolves at predetermined target revolutions per minute set in advance, to drive the main pumps 14 and the pilot pump 15, under direct or indirect control of the controller 30 that will be described later. The engine 11 is, for example, a diesel engine fueled with light oil.

The regulators 13 control the discharge amount of the main pumps 14. For example, in response to a control command from the controller 30, the regulators 13 adjust the angle of the swashplate (tilt angle) of the main pumps 14. The regulators 13 include, for example, regulators 13L and 13R as will be discussed later.

The main pumps 14, for example, like the engine 11, are mounted in the rear part of the revolving upper body 3, to supply hydraulic oil to the control valves 17 through high pressure hydraulic lines. As described above, the main pumps 14 are driven by the engine 11. Each of the main pumps 14 is, for example, a variable displacement hydraulic pump, and as described above, has the tilt angle of its swashplate adjusted by a regulator 13 under control of the controller 30; accordingly, the stroke length of the piston is adjusted, and thereby, the discharge flow (discharge pressure) is controlled. The main pumps 14 include main pumps 14L and 14R, for example, as will be discussed later.

Each of the control valves 17 is a hydraulic control device that is installed, for example, in the center part of the revolving upper body 3 for controlling the hydraulic drive system in response to an operation performed on the operation device 26 by the operator. As described above, the control valves 17 are connected to the main pumps 14 via high pressure hydraulic lines, and selectively supply hydraulic oil supplied from the main pumps 14 to hydraulic actuators (the hydraulic motors for traveling 1L and 1R, the hydraulic motor for revolution 2A, the boom cylinder 7, the arm cylinder 8, and the bucket cylinder 9), depending on the operational state of the operation device 26. Specifically, the control valves 17 include control valves 171-176 for controlling the flow and the direction of hydraulic oil supplied from the main pumps 14 to the respective hydraulic actuators. More specifically, the control valve 171 corresponds to the hydraulic motor for traveling 1L; the control valve 172 corresponds to the hydraulic motor for traveling 1R; and the control valve 173 corresponds to the hydraulic motor for revolution 2A. Also, the control valve 174 corresponds to the bucket cylinder 9; the control valves 175 correspond to the boom cylinder 7; and the control valves 176 correspond to the arm cylinder 8. Also, for example, as will be discussed later, the control valves 175 include control valves 175L and 175R; and, for example, as will be discussed later, the control valves 176 include control valves 176L and 176R. The control valves 171-176 will be described in detail later.

The operation system of the excavator 100 according to the present embodiment includes the pilot pump 15 and the operation device 26. Also, the operation system of the excavator 100 includes shuttle valves 32 as elements related to a machine control function implemented by the controller 30 that will be described later.

The pilot pump 15 is installed, for example, in the rear part of the revolving upper body 3, to supply pilot pressure to the operation device 26 via pilot lines. The pilot pump 15 is, for example, a fixed-capacity hydraulic pump, and driven by the engine 11 as described above.

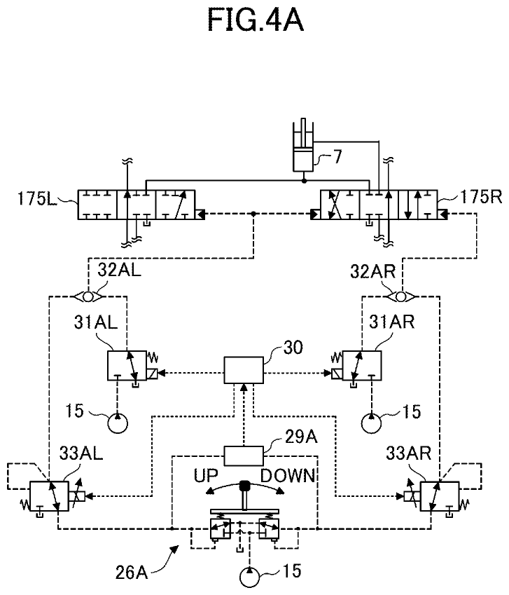

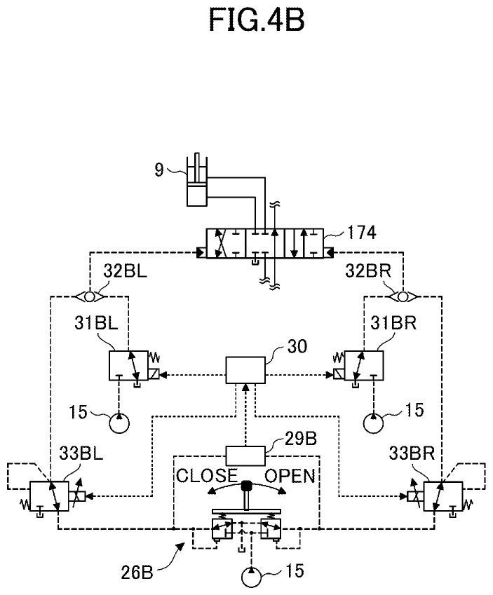

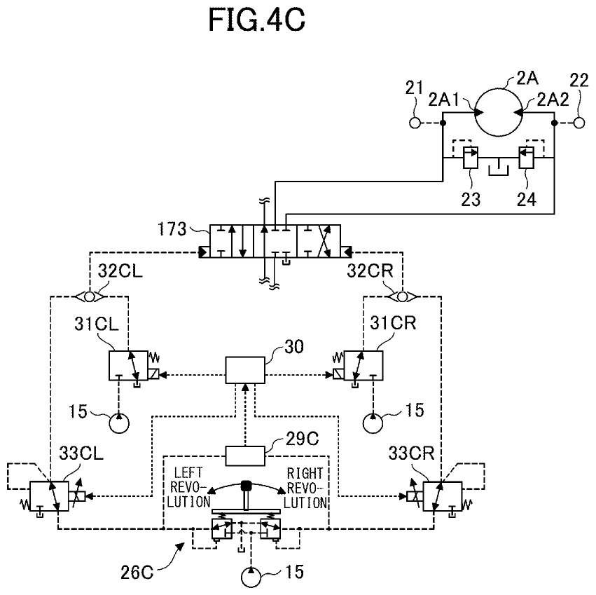

The operation device 26 is an operation input part provided around the cockpit in the cabin 10 for the operator to perform operations on various operating elements (the traveling lower body 1, the revolving upper body 3, the boom 4, the arm 5, the bucket 6, and the like). In other words, the operation device 26 is an operation input part for the operator to perform operations on the operating elements that drive the respective hydraulic actuators (i.e., the hydraulic motors for traveling 1L and 1R, the hydraulic motor for revolution 2A, the boom cylinder 7, the arm cylinder 8, and the bucket cylinder 9). The operation device 26 is connected to the control valves 17 directly via pilot lines on its secondary side, or indirectly via the shuttle valves 32 provided on the pilot lines on its secondary side, as will be described later. This enables the control valves 17 to receive as input pilot pressures depending on the operational states of the traveling lower body 1, the revolving upper body 3, the boom 4, the arm 5, the bucket 6, and the like in the operation device 26. Therefore, the control valves 17 can drive the respective hydraulic actuators depending on the operational state in the operation device 26. The operation device 26 includes, for example, a lever device to operate the arm 5 (the arm cylinder 8). Also, the operation device 26 includes, for example, lever devices 26A-26C to operate the boom 4 (the boom cylinder 7), the bucket 6 (the bucket cylinder 9), the revolving upper body 3 (the hydraulic motor for revolution 2A), respectively (see FIGS. 4A-4C). Also, the operation device 26 includes, for example, a lever device or a pedal device to operate each of the pair of crawlers on the left and right (the hydraulic motors for traveling 1L and 1R) of the traveling lower body 1.

Each shuttle valve 32 has two input ports and one output port, and among pilot pressures input into the two input port, outputs hydraulic oil having a higher pilot pressure to the output port. One of the two input ports of the shuttle valve 32 is connected to the operation device 26, and the other is connected to a corresponding proportional valve 31. Through the pilot line, the output port of the shuttle valve 32 is connected to the pilot port of a corresponding control valve in the control valves 17 (see FIGS. 4A-4C for details). Therefore, the shuttle valve 32 can cause a higher pressure among of the pilot pressure generated by the operation device 26 and the pilot pressure generated by the proportional valve 31, to work on the pilot port of the corresponding control valve. In other words, by outputting from the proportional valves 31 a pilot pressure higher than the pilot pressure on the secondary side output from the operation device 26, the controller 30 that will be described later can control the corresponding control valves, and control the operations of the various operating elements, regardless of an operation on the operation device 26 performed by the operator. For example, the shuttle valves 32 include shuttle valves 32AL, 32AR, 32BL, 32BR, 32CL, and 32CR as will be discussed later.

Note that the operation device 26 (a left operation lever, a right operation lever, a left traveling lever, and a right traveling lever) may be of an electric type that outputs an electrical signal, instead of a hydraulic pressure type that outputs pilot pressure. In this case, electrical signals from the operation device 26 are input into the controller 30, and depending on the input electrical signals, the controller 30 controls the corresponding control valves 171-176 among the control valves 17, to implement operations of the various hydraulic actuators according to the operational contents on the operation device 26. For example, each of the control valves 171-176 in the control valves 17 may be a solenoid spool valve driven by a command from the controller 30. Also, for example, between the pilot pump 15 and the pilot port of each of the control valve 171-176, a solenoid valve may be arranged that operates in response to an electrical signal from the controller 30. In this case, when a manual operation is performed using the electric operation device 26, the controller 30 controls the solenoid valve to increase or decrease the pilot pressure by an electrical signal corresponding to the amount of operation (e.g., the amount of lever operation), and thereby, can operate the corresponding control valves 171-176 according to the operational contents for the operation device 26.

The control system of the excavator 100 according to the present embodiment includes the controller 30, discharge pressure sensors 28, operational pressure sensors 29, proportional valves 31, a display device 40, an input device 42, a sound output device 43, a storage device 47, a boom angle sensor S1, an arm angle sensor S2, a bucket angle sensor S3, a machine tilt sensor S4, a revolution state sensor S5, an imaging device S6, a positioning device P0, and a communication device T1.

The controller 30 (an example of a control device) is provided, for example, in the cabin 10, and executes drive control of the excavator 100. Functions of the controller 30 may be implemented with any hardware components or software components, or combination of these. For example, the controller 30 is constituted primarily with a microcomputer that includes a CPU (Central Processing Unit), a ROM (Read-Only Memory), a RAM (Random Access Memory), a non-volatile auxiliary storage device, various input/output interfaces, and the like. The controller 30 implements various functions by, for example, the CPU executing various program stored, for example, in the ROM or the non-volatile auxiliary storage device.

For example, the controller 30 sets target revolutions per minute based on a work mode set in advance by a predetermined operation performed by the operator or the like, to execute drive control to revolve the engine 11 at a constant rate.

Also, for example, the controller 30 outputs a control command to the regulators 13 as required, to vary the amounts of discharge of the main pumps 14.

Also, for example, the controller 30 executes control related to, for example, a machine guidance function of guiding a manual operation of the excavator 100 performed by the operator through the operation device 26. Also, the controller 30 executes control related to, for example, a machine control function of automatically supporting a manual operation of the excavator 100 performed by the operator through the operation device 26. In other words, the controller 30 includes a machine guidance part 50 as a functional part for a machine guidance function and a machine control function. Also, the controller 30 includes an earth and sand load processing part 60 that will be described later.

Note that some of the functions of the controller 30 may be implemented by another controller (control devices). In other words, the functions of the controller 30 may be implemented in a way of being distributed among multiple controllers. For example, the machine guidance function and the machine control function may be implemented by a dedicated controller (a control device).

The discharge pressure sensors 28 detect the discharge pressures of the main pumps 14. Detection signals corresponding to the discharge pressures detected by the discharge pressure sensors 28 are taken into the controller 30. The discharge pressure sensors 28 include discharge pressure sensors 28L and 28R, for example, as will be discussed later.

As described above, each of the operational pressure sensors 29 detects a pilot pressure on the secondary side of the operation device 26, namely, the pilot pressure corresponding to the operational state (e.g., operational contents such as the operation direction and the amount of operation) related to each operating element in the operation device 26 (i.e., hydraulic actuator). Detection signals of pilot pressures corresponding to operational states of the traveling lower body 1, the revolving upper body 3, the boom 4, the arm 5, the bucket 6, and the like in the operation device 26 detected by the operational pressure sensors 29 are taken into the controller 30. The operational pressure sensors 29 include operational pressure sensors 29A-29C, for example, as will be discussed later.

Note that in place of the operational pressure sensors 29, other sensors capable of detecting operational states of the respective operating elements in the operation device 26, such as an encoder or potentiometer capable of detecting the amount of operation (tilt amount), the tilt direction, and the like of the lever devices 26A-26C, may be provided.

The proportional valves 31 are provided on pilot lines connecting the pilot pump 15 to the shuttle valves 32, and are configured to be capable of changing the flow area (cross sectional area through which hydraulic oil can flow). Each of the proportional valves 31 operates in response to a control command input from the controller 30. This enables, even in the case where the operation device (specifically, any of the lever devices 26A-26C) is not being operated by the operator, the controller 30 to provide hydraulic oil discharged from the pilot pump 15 to the pilot port of a corresponding control valve among the control valves 17 via the proportional valves 31 and the shuttle valves 32. The proportional valves 31 include, for example, proportional valves 31AL and 31AR, 31BL, 31BR, 31CL, and 31CR, as will be discussed later.

The display device 40 is provided at a location readily visible from the operator seated in the cabin 10, to display various informative images under control of the controller 30. The display device 40 may be connected to the controller 30 via a communication network such as a CAN (Controller Area Network), or may be connected to the controller 30 via dedicated one-to-one lines.

The input device 42 is provided within a range reachable by hand by the operator seated in the cabin 10, to receive various operation inputs by the operator, and to output signals according to the operation inputs to the controller 30. The input device 42 includes a touch panel mounted on a display of a display device to display various informative images, a knob switch provided at the tip of a lever part of each of the lever devices 26A-26C, a button switch, a lever, a toggle, a rotary dial, and the like, arranged around the display device 40. Signals corresponding to the operational contents on the input device 42 are taken into the controller 30.

The sound output device 43 is provided, for example, in the cabin 10, connected to the controller 30, and configured to output sound under control of the controller 30. The sound output device 43 is, for example, a speaker, a buzzer, or the like. The sound output device 43 outputs various items of information by sound in response to sound output commands from the controller 30.

The storage device 47 is provided, for example, in the cabin 10, and configured to store various items of information under control of the controller 30. The storage device 47 is, for example, a non-volatile storage medium such as a semiconductor memory. The storage device 47 may store information output by various devices during operations of the excavator 100, and may store information obtained via the various devices before operations of the excavator 100 is started. The storage device 47 may store, for example, data related to a target construction surface that is obtained via the communication device T1 or the like, or set through the input device 42 or the like. The target construction surface may be set (stored) by the operator of the excavator 100, or may be set by a construction manager or the like.

The boom angle sensor S1 is attached to the boom 4, to detect an elevation angle of the boom 4 with respect to the revolving upper body 3 (referred to as the “boom angle”, hereafter), for example, in a side view, an angle formed by a line connecting the supporting points at both ends of the boom 4, with respect to a revolution plane of the revolving upper body 3. The boom angle sensor S1 may include, for example, a rotary encoder, an acceleration sensor, a hexaxial sensor, an IMU (Inertial Measurement Unit), and the like. Also, the boom angle sensor S1 may include a potentiometer using a variable resistor, a cylinder sensor to detect the stroke amount of a hydraulic cylinder (the boom cylinder 7) corresponding to the boom angle, and the like. In the following, the same applies to the arm angle sensor S2 and the bucket angle sensor S3. A detection signal corresponding to the boom angle detected by the boom angle sensor S1 is taken into the controller 30.

The arm angle sensor S2 is attached to the arm 5, to detect an angle of rotation of the arm 5 with respect to the boom 4 (referred to as the “arm angle”, hereafter), for example, in a side view, an angle formed by a line connecting the supporting points at both ends of the boom 4, with respect to a line connecting the supporting points at both ends of the arm 5. A detection signal corresponding to the arm angle detected by the arm angle sensor S2 is taken into the controller 30.

The bucket angle sensor S3 is attached to the bucket 6, to detect the angle of rotation of the bucket 6 with respect to the arm 5 (referred to as the “bucket angle”, hereafter), for example, in a side view, an angle formed by a line connecting the supporting point of the bucket 6 and the tip (teeth edge), with respect to a line connecting the supporting points at both ends of the arm 5. A detection signal corresponding to the bucket angle detected by the bucket angle sensor S3 is taken into the controller 30.

The machine tilt sensor S4 detects the tilt state of a body (the revolving upper body 3 or the traveling lower body 1), for example, with respect to the horizontal plane. The machine tilt sensor S4 is attached to, for example, the revolving upper body 3, to detect biaxial tilt angles (referred to as the “back-and-forth tilt angle” and the “left-and-right tilt angle”, hereafter) of the excavator 100 (i.e., the revolving upper body 3) in the back-and-forth direction and in the left-and-right direction. The machine tilt sensor S4 may include, for example, a rotary encoder, an acceleration sensor, a hexaxial sensor, an IMU, and the like. Detection signals corresponding to the tilt angles (the back-and-forth tilt angle and the left-and-right tilt angle) by the machine tilt sensor S4 are taken into the controller 30.

The revolution state sensor S5 outputs detected information on the revolution state of the revolving upper body 3. The revolution state sensor S5 detects, for example, the revolutional angular velocity and the revolution angle of the revolving upper body 3. The revolution state sensor S5 may include, for example, a gyro sensor, a resolver, a rotary encoder, and the like. Detection signals corresponding to the revolution angle and the revolution angular velocity of the revolving upper body 3 detected by the revolution state sensor S5 are taken into the controller 30.

The imaging device S6 as a space recognition device captures images in the surroundings of the excavator 100. The imaging device S6 includes a camera S6F to capture an image of a space in front of the excavator 100; a camera S6L to capture an image of a space on the left of the excavator 100; a camera S6R to capture an image of a space on the right of the excavator 100; and a camera S6B to capture an image of a space behind the excavator 100.

The camera S6F is attached, for example, to the ceiling of the cabin 10, namely, to the inside of the cabin 10. Alternatively, the camera S6F may be attached to the outside of the cabin 10, such as the roof of the cabin 10 or a side surface of the boom 4. The camera S6L is attached to the left end on the top surface of the revolving upper body 3; the camera S6R is attached to the right end on the top surface of the revolving upper body 3; and the camera S6B is attached to the rear end on the top surface of the revolving upper body 3.

The imaging device S6 (or each camera S6F, S6B, S6L, or S6R) is, for example, a monocular wide angle camera having a very wide angle of field. Also, the imaging device S6 may be a stereo camera, a distance image camera, or the like. An image captured by the imaging device S6 is taken into the controller 30, via the display device 40.

The imaging device S6 as the space recognition device may function as an object detection device. In this case, the imaging device S6 may detect an object present in the surroundings of the excavator 100. The object to be detected includes, for example, a person, an animal, a vehicle, a construction machine, a building, a hole, and the like. Also, the imaging device S6 may calculate the distance from the imaging device S6 or the excavator 100 to the recognized object. The imaging device S6 as an object detecting device may include, for example, a stereo camera, a depth image camera, and a the like. Further, the space recognition device is, for example, a monocular camera having an imaging element such as a CCD or CMOS, and outputs a captured image to the display device 40. Also, the space recognition device may be configured to calculate the distance from the space recognition device or the excavator 100 to the recognized object. Also, in addition to the imaging device S6, as the space recognition device, other object detection devices such as an ultrasonic sensor, a millimeter wave radar, a LIDAR device, an infrared sensor, and the like, may be provided. In the case of using a millimeter-wave radar, ultrasonic sensor, laser radar, or the like as the space recognition device 80, such a sensor may transmit a number of signals (such as laser light rays) to an object, to receive the reflected signals, so as to detect the distance and the direction of the object from the reflected signals.

Note that the imaging device S6 may be communicably connected directly to the controller 30.

A boom rod pressure sensor S7R and a boom bottom pressure sensor S7B are attached to the boom cylinder 7. An arm rod pressure sensor S8R and an arm bottom pressure sensor S8B are attached to the arm cylinder 8. A bucket rod pressure sensor S9R and a bucket bottom pressure sensor S9B are attached to the bucket cylinder 9. The boom rod pressure sensor S7R, the boom bottom pressure sensor S7B, the arm rod pressure sensor S8R, the arm bottom pressure sensor S8B, the bucket rod pressure sensor S9R, the bucket bottom pressure sensor S9B are also collectively referred to as the “cylinder pressure sensors”.

The boom rod pressure sensor S7R detects the pressure of the oil chamber on the rod side of the boom cylinder 7 (hereafter, referred to as the “boom rod pressure”), and the boom bottom pressure sensor S7B detects the pressure of the oil chamber on the bottom side of the boom cylinder 7 (hereafter, referred to as the “boom bottom pressure”). The arm rod pressure sensor S8R detects the pressure of the oil chamber on the rod side of the arm cylinder 8 (hereafter, referred to as the “arm rod pressure”), and the arm bottom pressure sensor S8B detects the pressure of the oil chamber on the bottom side of the arm cylinder 8 (hereafter, referred to as the “arm bottom pressure”). The bucket rod pressure sensor S9R detects the pressure of the oil chamber on the rod side of the bucket cylinder 9 (hereafter, referred to as the “bucket rod pressure”), and the bucket bottom pressure sensor S9B detects the pressure of the oil chamber on the bottom side of the bucket cylinder 9 (hereafter, referred to as the “bucket bottom pressure”).

The positioning device P0 measures the position and the orientation of the revolving upper body 3. The positioning device P0 is, for example, a GNSS (Global Navigation Satellite System) compass to detect the position and the orientation of the revolving upper body 3, and detection signals corresponding to the position and the orientation of the revolving upper body 3 are taken into the controller 30. Also, the function of detecting the orientation of the revolving upper body 3 among the functions of the positioning device P0 may be replaced by an orientation sensor attached to the revolving upper body 3.

The communication device T1 communicates with an external device through a predetermined network including a mobile communication network having base stations at the ends, a satellite communication network, the Internet, and the like. The communication device T1 is, for example, a mobile communication module compliant with mobile communication standards such as LTE (Long Term Evolution), 4G (4th Generation), and 5G (5th Generation), a satellite communication module for connecting to a satellite communication network, or the like.

The machine guidance part 50, for example, executes control of the excavator 100 related to the machine guidance function. The machine guidance part 50 transmits working information, for example, the distance between the target construction surface and the tip of the attachment, specifically, a working part of the end attachment and the like to the operator through the display device 40, the sound output device 43, and the like. Data related to the target construction surface is stored in advance in the storage device 47, for example, as described above. The data related to the target construction surface is represented, for example, in a reference coordinate system. The reference coordinate system is, for example, the World Geodetic System. The World Geodetic System is a three-dimensional orthogonal XYZ coordinate system that has the origin at the center of gravity of the Earth, the X-axis in the direction of the intersection of the Greenwich meridian and the equator, the Y-axis in the direction of longitude 90 degrees east, and the Z-axis in the direction of the North Pole. The operator may define any point on the construction site as the reference point, to set the target construction surface through the input device 42 in a relative positional relationship with respect to the reference point. The working part of the bucket 6 is, for example, the teeth end of the bucket 6, the back face of the bucket 6, or the like. Also, as the end attachment, instead of the bucket 6, for example, in the case of adopting a breaker, the tip of the breaker corresponds to the working part. The machine guidance part 50 informs the operator of the operation information through the display device 40, the sound output device 43, and the like, to guide operations of the excavator 100 performed by the operator through the operation device 26.

Also, the machine guidance part 50, for example, executes control of the excavator 100 related to the machine guidance function. For example, when the operator is performing an excavation operation manually, the machine guidance part 50 may cause at least one of the boom 4, the arm 5, and the bucket 6 to operate automatically, so as to have the tip position of the bucket 6 coincident with the target construction surface.

The machine guidance part 50 obtains information from the boom angle sensor S1, the arm angle sensor S2, the bucket angle sensor S3, the machine tilt sensor S4, the revolution state sensor S5, the imaging device S6, the positioning device P0, the communication device T1, and the input device 42. Then, for example, based on the obtained information, the machine guidance part 50 calculates the distance between the bucket 6 and the target construction surface; informs the operator of the degree of the distance between the bucket 6 and the target construction surface, through a sound from the sound output device 43 and an image displayed on the display device 40; and controls the operation of the attachment automatically, so as to have the tip of the attachment (specifically, the working part such as the teeth end or the back face of the bucket 6) coincident with the target construction surface. The machine guidance part 50 includes a position calculating part 51, a distance calculating part 52, an information transfer part 53, an automatic control part 54, a revolution angle calculating part 55, and a relative angle calculating part 56, as detailed functional elements related to the machine guidance function and the machine control function.

The position calculating part 51 calculates the position of a predetermined positioning target. For example, the position calculating part 51 calculates the coordinate point of the tip of the attachment, specifically, the working part such as the teeth end or the back face of the bucket 6, in the reference coordinate system. Specifically, the position calculating part 51 calculates the coordinate point of the working part of the bucket 6 from the respective elevation angles (the boom angle, the arm angle, and the bucket angle) of the boom 4, the arm 5, and the bucket 6.

The distance calculating part 52 calculates the distance between two positioning targets. For example, the distance calculating part 52 calculates the distance between the tip of the attachment, specifically, the working part such as the teeth end or the back face of the bucket 6, and the target construction surface. Also, the distance calculating part 52 may calculate an angle (a relative angle) between the back face as the working part for the bucket 6, and the target construction surface.

The information transfer part 53 transfers (notifies) various information items to the operator of the excavator 100 through a predetermined notification part such as the display device 40 and the sound output device 43. The information transfer part 53 notifies the magnitude (degree) of the various distances and the like calculated by the distance calculating part 52, to the operator of the excavator 100. For example, by using at least one of visual information provided by the display device 40, and auditory information provided by the sound output device 43, the information transfer part 53 transmits (the magnitude of) the distance between the tip of the bucket 6 and the target construction surface to the operator. Also, by using at least one of visual information provided by the display device 40, and auditory information provided by the sound output device 43, the information transfer part 53 may transmit (the magnitude of) the relative angle between the back face as the working part for the bucket 6 and the target construction surface to the operator.

Specifically, the information transfer part 53 uses intermittent noise generated by the sound output device 43, to transmit the magnitude of the distance (e.g., vertical distance) between the working part of the bucket 6 and the target construction surface to the operator. In this case, the information transfer part 53 may shorten the interval of the intermittent noise as the vertical distance becomes shorter, and lengthen the interval of the intermittent noise as the vertical distance becomes longer. Also, the information transfer part 53 may use a continuous sound, to express difference in the magnitude of the vertical distance while varying the pitch, intensity, and the like of the sound. Also, in the case where the tip of the bucket 6 comes lower than the target construction surface, namely, exceeds the target construction surface, the information transfer part 53 may issue an alarm through the sound output device 43. The alarm is, for example, a continuous sound that is significantly greater than the intermittent noise.

Also, the information transfer part 53 may cause the display device 40 to display the magnitude of the distance between the tip of the attachment, specifically, a working part of the bucket 6, and the target construction surface, and the magnitude of the relative angle between the back face of the bucket 6 and the target construction surface, as working information. The display device 40 displays the working information received from the information transfer part 53, for example, together with image data received from the imaging device S6, under control of the controller 30. The information transfer part 53 may use, for example, an image of an analog meter, an image of a bar graph indicator, or the like, to transmit the magnitude of the vertical distance to the operator.

The automatic control part 54 is configured to automatically support a manual operation of the excavator 100 performed by the operator, by causing the actuators to operate automatically. Specifically, as will be discussed later, the automatic control part 54 can adjust pilot pressure acting on the control valves (specifically, the control valves 173, 175L, 175R, and 174) corresponding to the multiple hydraulic actuators (specifically, the hydraulic motor for revolution 2A, the boom cylinder 7, and the bucket cylinder 9) independently and automatically. This enables the automatic control part 54 to cause each of the hydraulic actuator to operate automatically. The control related to the machine control function by the automatic control part 54 may be executed, for example, when a predetermined switch included in the input devices 42 is pressed. The predetermined switch may be, for example, a machine control switch (hereafter, referred to as the “MC switch”) arranged as a knob switch at the tip of the operation device 26 to be gripped by the operator (e.g., a lever device corresponding to the operation of the arm 5). It is assumed in the following description that that the machine control function is enabled while the MC switch is being pressed.

For example, in the case where the MC switch or the like is being pressed, in order to assist excavation work or shaping work, the automatic control part 54 causes at least one of the boom cylinder 7 and the bucket cylinder 9 to extend or contract automatically according to the operation of the arm cylinder 8. Specifically, in the case where the operator manually performs a closing operation of the arm 5 (referred to as the “arm closing operation”, hereafter), the automatic control part 54 causes at least one of the boom cylinder 7 and the bucket cylinder 9 to extend or contract automatically, so as to have the target construction surface coincident with the position of the working part such as the teeth end, the back face, or the like of the bucket 6. In this case, for example, by simply operating the lever device corresponding to the operation of the arm 5, the operator can close the arm 5 while having the teeth end or the like of the bucket 6 coincident with the target construction surface.

Also, in the case where the MC switch is being pressed, in order to cause the revolving upper body 3 to face the target construction surface, the automatic control part 54 may cause the hydraulic motor for revolution 2A (an example of an actuator) to revolve automatically. In the following, the control executed by the controller 30 (the automatic control part 54) to cause the revolving upper body 3 to face the target construction surface, will be referred to as “facing control”. This allows the operator or the like to cause the revolving upper body 3 to face the target construction surface, by simply pressing a predetermined switch, or operating the lever device 26C that will be described later, corresponding to the revolution operation in a state of the switch being pressed. Also, by simply pressing the MC switch, the operator can cause the revolving upper body 3 to face the target construction surface, and initiate the machine control function related to excavation work of the target construction surface described above.

For example, the state of the revolving upper body 3 of the excavator 100 facing the target construction surface is a state in which the tip of the attachment (e.g., the teeth end, the back face, or the like as the working part of the bucket 6) can be moved along the tilt direction of the target construction surface (the upward slope surface BS) according to operations of the attachment. Specifically, the state of the revolving upper body 3 of the excavator 100 facing the target construction surface is a state in which the working face of the attachment (the working attachment face) vertical to the revolution plane of the excavator 100 includes a normal to the target construction surface corresponding to the cylindrical body (i.e., a state of extending along the normal).

In the case where the working attachment face of the excavator 100 is not in a state of including the normal to the target construction surface corresponding to the cylindrical body, the tip of the attachment cannot be moved to the target construction surface in the tilt direction. Therefore, as a result, the excavator 100 cannot execute construction on the target construction surface. In contrast, by causing the hydraulic motor for revolution 2A to revolve automatically, the automatic control part 54 can cause the revolving upper body 3 to face the target construction surface. Accordingly, the excavator 100 can execute construction work on the target construction surface.

In the facing control, the automatic control part 54 determines that the excavator faces the target construction surface, for example, in the case where a left end vertical distance between the coordinate point of the left end on the teeth end of the bucket 6 and the target construction surface (simply referred to as the “left end vertical distance”, hereafter) becomes equal to a right end vertical distance between the coordinate point of the right end on the teeth end of the bucket 6 and the target construction surface (simply referred to as the “right end vertical distance”, hereafter). Also, not in the case where the left end vertical distance becomes equal to the right end vertical distance (i.e., in the case where the difference between the left end vertical distance and the right end vertical distance becomes zero), or in the case where the difference becomes less than or equal to a predetermined value, the automatic control part 54 may determine that the excavator 100 faces the target construction surface.

Also, in the facing control, the automatic control part 54 may cause the hydraulic motor for revolution 2A to operate, for example, based on the difference between the left end vertical distance and the right end vertical distance. Specifically, when the lever device 26C corresponding to the revolution operation is operated in a state of the predetermined switch such as the MC switch is being pressed, the automatic control part 54 determines whether or not the lever device 26C is operated in a direction in which the revolving upper body 3 comes to face the target construction surface. For example, in the case where the lever device 26C is operated in a direction in which the vertical distance between the teeth end of the bucket 6 and the target construction surface (the upward slope surface BS) becomes greater, the automatic control part 54 does not execute the facing control. On the other hand, in the case where the lever device 26C is operated in a direction in which the vertical distance between the teeth end of the bucket 6 and the target construction surface (the upward slope surface BS) becomes smaller, the automatic control part 54 executes the facing control. As a result, the automatic control part 54 can cause the hydraulic motor for revolution 2A to operate so as to make the difference between the left end vertical distance and the right end vertical distance smaller. Thereafter, once the difference becomes less than or equal to the predetermined value or zero, the automatic control part 54 stops the hydraulic motor for revolution 2A. Also, the automatic control part 54 may control the operation of the hydraulic motor for revolution 2A, by setting a revolution angle at which the difference is less than or equal to the predetermined value or zero as the target angle, making the angular difference between the target angle and the current revolution angle (specifically, a detected value based on a detection signal of the revolution state sensor S5) become zero. In this case, the revolution angle is, for example, an angle of the back-and-forth axis of the revolving upper body 3 with respect to a reference direction.

Note that as described above, instead of the hydraulic motor for revolution 2A, in the case where an electric motor for revolution is installed in the excavator 100, the automatic control part 54 executes the facing control with respect to the electric motor for revolution (an example of an actuator) as the control target.

The revolution angle calculating part 55 calculates the revolution angle of the revolving upper body 3. This enables the controller 30 to identify the current orientation of the revolving upper body 3. The revolution angle calculating part 55 calculates the angle of the back-and-forth axis of the revolving upper body 3 with respect to the reference direction as the revolution angle, based on, for example, the output signal of the GNSS compass included in the positioning device P0. Also, the revolution angle calculating part 55 may calculate the revolution angle based on the detection signal of the revolution state sensor S5. Also, in the case where a reference point is set at the construction site, the revolution angle calculating part 55 may set a direction of viewing the reference point from the revolution axis, as the reference direction.

The revolution angle indicates a direction in which the working attachment face extends with respect to the reference direction. The working attachment face is, for example, a virtual plane extending over the attachment, and is arranged to be perpendicular to the revolution plane. The revolution plane is a virtual plane that includes, for example, a bottom surface of the revolution frame perpendicular to the revolution axis. For example, in the case where it is determined that the working attachment face contains the normal to the target construction surface, the controller 30 (the machine guidance part 50) determines that the revolving upper body 3 faces the target construction surface.

The relative angle calculating part 56 calculates the revolution angle (relative angle) required to cause the revolving upper body 3 to face the target construction surface. The relative angle is a relative angle formed, for example, between a direction of the back-and-forth axis of the revolving upper body 3 when the revolving upper body 3 faces the target construction surface, and the current direction of the back-and-forth axis of the revolving upper body 3. The relative angle calculating part 56 calculates the relative angle based on, for example, the data related to the target construction surface stored in the storage device 47, and the revolution angle calculated by the revolution angle calculating part 55.

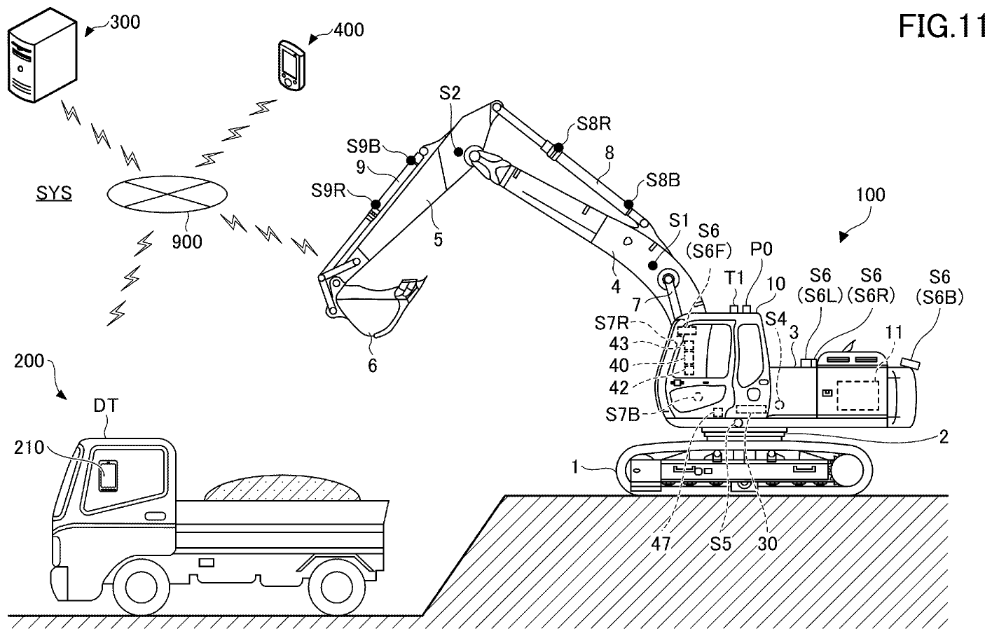

When the lever device 26C corresponding to the revolution operation is operated in a state of the predetermined switch such as the MC switch being pressed, the automatic control part 54 determines whether or not a revolution operation is executed in a direction that causes the revolving upper body 3 to come to face the target construction surface. In the case where it is determined that a revolution operation is executed in the direction in which the revolving upper body 3 comes to face the target construction surface, the automatic control part 54 sets the relative angle calculated by the relative angle calculating part 56 as the target angle. Then, in the case where the change in the revolution angle after the lever device 26C was operated reaches the target angle, the automatic control part 54 may determine that the revolving upper body 3 faces the target construction surface, to stop the motion of the hydraulic motor for revolution 2A. This enables the automatic control part 54 to cause the revolving upper body 3 to face the target construction surface, assuming the configuration illustrated in FIG. 2. In the application example of the facing control described above, although cases of the facing control on the target construction surface are shown, the application is not limited as such. For example, in a scoop-up operation executed when loading temporarily placed earth and sand into a dump truck DT (see FIG. 11), the facing control may be applied to the revolution operation, by generating a target excavation trajectory corresponding to a target volume, and causing the attachment to face the target excavation trajectory. In this case, the target excavation trajectory is changed each time a scoop-up operation is completed. Therefore, after discharging the ES into the dump truck DT, the facing control is executed with respect to the new target excavation trajectory.

Also, the hydraulic motor for revolution 2A has a first port 2A1 and a second port 2A2. A hydraulic sensor 21 detects pressure of hydraulic oil acting on the first port 2A1 of the hydraulic motor for revolution 2A. A hydraulic sensor 22 detects pressure of hydraulic oil acting on the second port 2A2 of the hydraulic motor for revolution 2A. Detection signals corresponding to the discharge pressures detected by the hydraulic sensors 21 and 22 are taken into the controller 30.

Also, the first port 2A1 is connected to the hydraulic oil tank via a relief valve 23. The relief valve 23 opens in the case where the pressure on the first port 2A1 side reaches a predetermined relief pressure, to discharge the hydraulic oil on the first port 2A1 side to the hydraulic oil tank. Similarly, the second port 2A2 is connected to the hydraulic oil tank via a relief valve 24. The relief valve 24 opens in the case where the pressure on the second port 2A2 side reaches a predetermined relief pressure, to discharge the hydraulic oil on the second port 2A2 side to the hydraulic oil tank. [Hydraulic system of excavator]

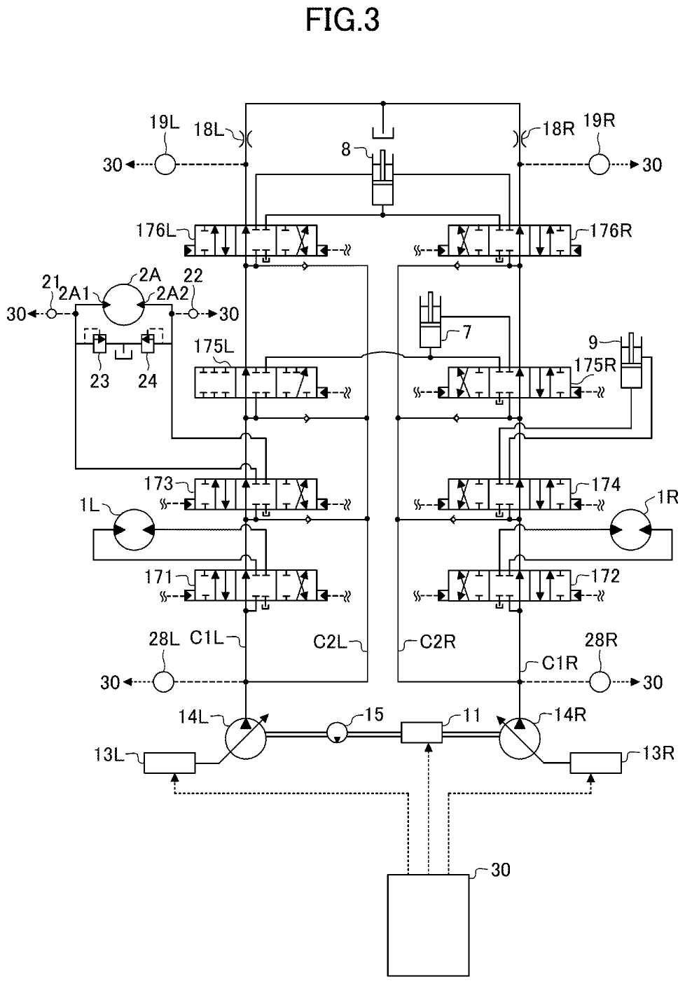

Next, with reference to FIG. 3, the hydraulic system of the excavator 100 according to the present embodiment will be described.

FIG. 3 schematically illustrates an example of a configuration of the hydraulic system of the excavator 100 according to the present embodiment.

Note that in FIG. 3, a mechanical power transmission system, hydraulic oil lines, pilot lines, and an electric control system are designated with double lines, solid lines, dashed lines, and dotted lines, respectively, as in the case of FIG. 2.

The hydraulic system implemented by the hydraulic circuit circulates hydraulic oil from the main pumps 14L and 14R driven by the engine 11, through center bypass oil paths C1L and C1R, and parallel oil paths C2L and C2R respectively, to the hydraulic oil tank.

The center bypass oil path C1L starts at the main pump 14L, passes through the control valves 171, 173, 175L, and 176L arranged in the control valves 17 in this order, and reaches the hydraulic oil tank.

The center bypass oil path C1R starts at the main pump 14R, passes through the control valves 172, 174, 175R, and 176R arranged in the control valves 17 in this order, and reaches the hydraulic oil tank.

The control valve 171 is a spool valve that supplies hydraulic oil discharged from the main pump 14L to the hydraulic motor for traveling 1L, and discharges the hydraulic oil discharged by the hydraulic motor for traveling 1L to the hydraulic oil tank.

The control valve 172 is a spool valve that supplies hydraulic oil discharged from the main pump 14R to the hydraulic motor for traveling 1R, and discharges the hydraulic oil discharged by the hydraulic motor for traveling 1R to the hydraulic oil tank.

The control valve 173 is a spool valve that supplies hydraulic oil discharged from the main pump 14L to the hydraulic motor for revolution 2A, and discharges the hydraulic oil discharged by the hydraulic motor for revolution 2A to the hydraulic oil tank.

The control valve 174 is a spool valve that supplies hydraulic oil discharged from the main pump 14R to the bucket cylinder 9, and discharges the hydraulic oil in the bucket cylinder 9 to the hydraulic oil tank.

The control valves 175L and 175R are spool valves that supply hydraulic oil discharged from the main pumps 14L and 14R, respectively, to the boom cylinder 7, and discharge the hydraulic oil in the boom cylinder 7 to the hydraulic oil tank.

The control valves 176L and 176R supply hydraulic oil discharged from the main pumps 14L and 14R, respectively, to the arm cylinder 8, and discharge the hydraulic oil in the arm cylinder 8 to the hydraulic oil tank.

Each of the control valves 171, 172, 173, 174, 175L, 175R, 176L, and 176R adjusts the flow of hydraulic oil supplied and discharged with respect to a corresponding hydraulic actuator, and changes the direction of the flow, depending on the pilot pressure acting on the pilot port.

In parallel to the center bypass oil path C1L, the parallel oil path C2L supplies hydraulic oil of the main pump 14L to the control valves 171, 173, 175L, and 176L. Specifically, the parallel oil path C2L branches off from the center bypass oil path C1L on the upstream side of the control valves 171, and is configured to be capable of supplying hydraulic oil of the main pump 14L to the control valves 171, 173, 175L, and 176R in parallel. This enables the parallel oil path C2L to supply hydraulic oil to a control valve located on the downstream side, in the case where the flow of hydraulic oil through the center bypass oil path C1L is restricted or cut off by any of the control valves 171, 173, and 175L.

In parallel to the center bypass oil path C1R, the parallel oil path C2R supplies hydraulic oil of the main pump 14R to the control valves 172, 174, 175R, and 176R. Specifically, the parallel oil path C2R branches off from the center bypass oil path C1R on the upstream side of the control valves 172, and is configured to be capable of supplying hydraulic oil of the main pump 14R to the control valves 172, 174, 175R, and 176R in parallel. The parallel oil path C2R can supply hydraulic oil to a control valve located on the downstream side, in the case where the flow of hydraulic oil through the center bypass oil path C1R is restricted or cut off by any of the control valves 172, 174, and 175R.

The regulators 13L and 13R adjust the amounts of discharge of the main pump 14L and 14R by adjusting the tilting angles of the swash plates of the main pumps 14L and 14R, respectively, under control of the controller 30.

The discharge pressure sensor 28L detects the discharge pressure of the main pumps 14L, and a detection signal corresponding to the detected discharge pressure is taken into the controller 30. The same applies to the discharge pressure sensor 28R. This enables the controller 30 to control the regulators 13L and 13R in response to the discharge pressures of the main pumps 14L and 14R.

Along the center bypass oil paths C1L and C1R, between each of the control valves 176L and 176R at most downstream locations and the hydraulic oil tank, negative control throttles 18L and 18R are provided (referred to as the “negative control throttles”, hereafter). With this configuration, the flow of hydraulic oil discharged by the main pumps 14L and 14R is restricted by the negative control throttles 18L and 18R. In addition, the negative control throttles 18L and 18R generate control pressures for controlling the regulators 13L and 13R (referred to as the “negative control pressures”, hereafter)

The negative control pressure sensors 19L and 19R detect the negative control pressures, and detection signals corresponding to the detected negative control pressures are taken into the controller 30.

The controller 30 may control the regulators 13L and 13R according to the discharge pressures of the main pumps 14L and 14R detected by the discharge pressure sensors 28L and 28R, to adjust the amounts of discharge of the main pumps 14L and 14R. For example, the controller 30 may control the regulator 13L in response to an increase of the discharge pressure of the main pump 14L, to adjust the tilt angle of the swashplate of the main pump 14L, so as to reduce the discharge amount. The same applies to the regulator 13R. This enables the controller 30 to execute full horsepower control such that the absorbed horsepower of the main pumps 14L and 14R, which is expressed by a product of the discharge pressure and the discharge volume, so as not exceed the output horsepower of the engine 11.

Also, the controller 30 may adjust the amounts of discharge of the main pumps 14L and 14R, by controlling the regulators 13L and 13R according to the negative control pressures detected by the negative control pressure sensors 19L and 19R. For example, the controller 30 reduces the amounts of discharge of the main pumps 14L and 14R as the negative control pressures increase, and increases the amounts of discharge of the main pumps 14L and 14R as the negative control pressures decrease.

Specifically, in the case of a standby state in which none of the hydraulic actuators in the excavator 100 is operated (a state illustrated in FIG. 3), the hydraulic oil discharged from the main pumps 14L and 14R passes through the center bypass oil paths C1L and C1R, and reaches the negative control throttles 18L and 18R. Then, the flow of the hydraulic oil discharged from the main pumps 14L and 14R increases the negative control pressures generated upstream of the negative control throttles 18L and 18R. As a result, the controller 30 reduces the amounts of discharge of the main pumps 14L and 14R down to the minimum allowable amount of discharge, and suppresses the pressure loss (pumping loss) when the discharged hydraulic oil passes through the center bypass oil paths C1L and C1R.

On the other hand, in the case where any of the hydraulic actuators is operated through the operation device 26, the hydraulic oil discharged from the main pumps 14L and 14R flows into a hydraulic actuator to be operated through a control valve corresponding to the hydraulic actuator to be operated. Then, the flow of the hydraulic oil discharged from the main pumps 14L and 14R reduces or eliminates the amounts reaching the negative control throttles 18L and 18R, and reduces the negative control pressures generated upstream of the negative control throttles 18L and 18R. As a result, the controller 30 can increase the amounts of discharge of the main pumps 14L and 14R, circulate sufficient hydraulic oil to the hydraulic actuator to be operated, and reliably drive the hydraulic actuator to be operated.

### [Details of Configuration Related to Machine Control Function of Excavator]

Next, with reference to FIG. 4A to 4C, a configuration of the excavator 100 related to the machine control function will be described in detail.

FIGS. 4A to 4C are diagrams each illustrating an example of part of the configuration related to the operation system in the hydraulic system of the excavator 100 according the present embodiment. Specifically, FIG. 4A is a diagram illustrating an example of a pilot circuit for applying pilot pressures to the control valves 175L and 175R that execute hydraulic control of the boom cylinder 7. Also, FIG. 4B is a diagram illustrating an example of a pilot circuit for applying pilot pressures to the control valve 174 that executes hydraulic control of the bucket cylinder 9. Also, FIG. 4C is a diagram illustrating an example of a pilot circuit for applying pilot pressures to the control valve 173 that executes hydraulic control of the hydraulic motor for revolution 2A.

Also, for example, as illustrated in FIG. 4A, the lever device 26A is used by the operator or the like for operating the boom cylinder 7 corresponding to the boom 4. The lever device 26A uses hydraulic oil discharged from the pilot pump 15, to output a pilot pressure corresponding to the operational contents on the secondary side.

The shuttle valve 32AL has one of the two input ports connected to a pilot line on the secondary side of the lever device 26A corresponding an operation in the upward direction of the boom 4 (referred to as the “boom-up operation”, hereafter); the other input port connected to a pilot line on the secondary side of the proportional valve 31AL; and the output port connected to the right pilot port of control valve 175L and the left pilot port of the control valve 175R.

The shuttle valve 32AR has one of the two input port connected to a pilot line on the secondary side of the lever device 26A corresponding to an operation in the downward direction of the boom 4 in the DN direction (referred to as the “boom-down operation”, hereafter); the other input port connected to a pilot line on the secondary side of the proportional valve 31AR; and the output port connected to the right pilot port of the control valve 175R.

In other words, the lever device 26A causes pilot pressures according to operational contents (e.g., operation direction and operation amount) to work on the pilot ports of the control valves 175L and 175R via the shuttle valves 32AL and 32AR. Specifically, in the case where a boom-up operation is performed, the lever device 26A outputs a pilot pressure according the amount of operation to one of the input ports of the shuttle valve 32AL, to work on the right pilot port of the control valve 175L and the left pilot port of the control valve 175R via the shuttle valve 32AL. Also, in the case a boom-down operation is performed, the lever device 26A outputs a pilot pressure according the amount of operation to one of the input ports of the shuttle valve 32AR, to work on the right pilot port of the control valve 175R via the shuttle valve 32AR.

The proportional valve 31AL operates in response to a control current input from the controller 30. Specifically, the proportional valve 31AL uses hydraulic oil discharged from the pilot pump 15, to output a pilot pressure according to the control current input from the controller 30, to the other input port of the shuttle valve 32AL. This enables the proportional valve 31AL to adjust the pilot pressure acting on the right pilot port of the control valve 175L and the left pilot port of the control valve 175R via the shuttle valve 32AL.

The proportional valve 31AR operates in response to a control current input from the controller 30. Specifically, the proportional valve 31AR uses hydraulic oil discharged from the pilot pump 15, to output a pilot pressure according to the control current input from the controller 30, to the other input port of the shuttle valve 32AR. This enables the proportional valve 31AR to adjust the pilot pressure acting on the right pilot port of the control valve 175R via the shuttle valve 32AR.

In other words, the proportional valves 31AL and 31AR can adjust the pilot pressures to be output on the secondary side, so as to stop the control valves 175L and 175R at any valve positions, regardless of the operational state of the lever device 26A.

Like the proportional valve 31AL, a proportional valve 33AL functions as a control valve for machine control. The proportional valve 33AL is arranged on a pipeline connecting the operation device 26 and the corresponding shuttle valve 32AL, and is configured to be capable of changing the flow area of the pipeline. In the present embodiment, the proportional valve 33AL operates in response to a control command output by the controller 30. Therefore, regardless of an operation on the operation device 26 performed by the operator, the controller 30 can supply hydraulic oil discharged by the operation device 26, after reducing the pressure of the hydraulic oil, to the pilot port of a corresponding control valve from among the control valves 17, via the shuttle valve 32AL.

Similarly, a proportional valve 33AR functions as a control valve for machine control. The proportional valve 33AR is arranged on a pipeline connecting the operation device 26 and the corresponding shuttle valve 32AR, and is configured to be capable of changing the flow area of the pipeline. In the present embodiment, the proportional valve 33AR operates in response to a control command output by the controller 30. Therefore, regardless of an operation on the operation device 26 performed by the operator, the controller 30 can supply hydraulic oil discharged by the operation device 26, after reducing the pressure of the hydraulic oil, to the pilot port of a corresponding control valve from among the control valves 17, via the shuttle valve 32AR.

The operational pressure sensor 29A detects the operational contents with respect to the lever device 26A performed by the operator, as a pressure (operational pressure), and a detection signal corresponding to the detected pressure is taken into the controller 30. This enables the controller 30 to grasp the operational contents performed on the lever device 26A.

The controller 30 can supply hydraulic oil discharged from the pilot pump 15 to the right pilot port of the control valve 175L and the left pilot port of the control valve 175R, via the proportional valve 31AL and the shuttle valve 32AL, regardless of the boom-up operation on the lever device 26A performed by the operator. Also, the controller 30 can supply hydraulic oil discharged from the pilot pump 15 to the right pilot port of the control valve 175R via the proportional valve 31AR and the shuttle valve 32AR, regardless of the boom-down operation on the lever device 26A performed by the operator. In other words, the controller 30 can control up and down operations of the boom 4 automatically. Also, even in the case where an operation is being performed on a particular operation device 26, the controller 30 can forcibly stop the operation of the hydraulic actuator corresponding to the particular operation device 26.

The proportional valve 33AL operates in response to a control command (a current command) output by the controller 30. Then, the proportional valve 33AL reduces the pilot pressure that is generated with hydraulic oil from the pilot pump 15, and introduced to the right pilot port of the control valve 175L and to the left pilot port of the control valve 175R, via the lever device 26A, the proportional valve 33AL, and the shuttle valve 32AL. The proportional valve 33AR operates in response to a control command (a current command) output by the controller 30. Also, it reduces the pilot pressure that is generated with hydraulic oil from the pilot pump 15, and introduced to the right pilot port of the control valve 175R, via the lever device 26A, the proportional valve 33AR, and the shuttle valve 32AR. The proportional valves 33AL and 33AR can adjust the pilot pressures so as to stop the control valves 175L and 175R at any respective valve positions.

With this configuration, even in the case where a boom-up operation is being performed by the operator, if required, the controller 30 can reduce the pilot pressures acting on the pilot ports on the boom-up side of the control valves 175 (the left pilot port of the control valve 175L and the right pilot port of the control valve 175R), to forcibly stop the closing operation of the boom 4. The same applies to the case of forcibly stopping a boom-down operation of the boom 4 while the boom-down operation is being performed by the operator.

Alternatively, even in the case where a boom-up operation is performed by the operator, if required, the controller 30 may control the proportional valve 31AR to increase the pilot pressure acting on the pilot port on the boom-down side of the control valves 175 (the right pilot port of the control valve 175R) on the opposite side of the pilot ports with respect to the boom-up side of the control valves 175, so as to forcibly return the control valves 175 to the neutral position, and thereby, to forcibly stop the boom-up operation of the boom 4. In this case, the proportional valve 33AL may be omitted. The same applies to the case of forcibly stopping a boom-down operation of the boom 4 while the boom-down operation is being performed by the operator.

As illustrated in FIG. 4B, the lever device 26B is used by the operator or the like for operating the bucket cylinder 9 corresponding to the bucket 6. The lever device 26B uses hydraulic oil discharged from the pilot pump 15, to output a pilot pressure corresponding to the operational contents on the secondary side.

The shuttle valve 32BL has one of the two input port connected to a pilot line on the secondary side of the lever device 26B corresponding to an operation of the bucket 6 in the closing direction (referred to as the “bucket closing operation”, hereafter); the other input port connected to a pilot line on the secondary side of the proportional valve 31BL; and the output port connected to the left pilot port of the control valve 174.

The shuttle valve 32BR has one of the two input port connected to a pilot line on the secondary side of the lever device 26B corresponding to an operation of the bucket 6 in the opening direction (referred to as the “bucket opening operation”, hereafter); the other input port connected to a pilot line on the secondary side of the proportional valve 31BR; and the output port connected to the right pilot port of the control valve 174.

In other words, the lever device 26B causes pilot pressures according to operational contents to work on the pilot ports of the control valve 174 via the shuttle valves 32BL and 32BR. Specifically, in the case a bucket closing operation is performed, the lever device 26B outputs a pilot pressure according the amount of operation to one of the input ports of the shuttle valve 32BL, to work on the left pilot port of the control valve 174 via the shuttle valve 32BL. Also, in the case a bucket opening operation is performed, the lever device 26B outputs a pilot pressure according the amount of operation to one of the input ports of the shuttle valve 32BR, to work on the right pilot port of the control valve 174 via the shuttle valve 32BR.

The proportional valve 31BL operates in response to a control current input from the controller 30. Specifically, the proportional valve 31BL uses hydraulic oil discharged from the pilot pump 15, to output a pilot pressure according to the control current input from the controller 30, to the other pilot port of the shuttle valve 32BL. This enables the proportional valve 31BL to adjust the pilot pressure acting on the left pilot port of the control valve 174 via the shuttle valve 32BL.

The proportional valve 31BR operates in response to a control current output by the controller 30. Specifically, the proportional valve 31BR uses hydraulic oil discharged from the pilot pump 15, to output a pilot pressure according to the control current input from the controller 30, to the other pilot port of the shuttle valve 32BR. This enables the proportional valve 31BR to adjust the pilot pressure acting on the right pilot port of the control valve 174 via the shuttle valve 32BR.

In other words, the proportional valves 31BL and 31BR can adjust the pilot pressures to be output on the secondary side, so as to stop the control valve 174 at any valve position, regardless of the operational state of the lever device 26B.

Like the proportional valve 31BL, a proportional valve 33BL functions as a control valve for machine control. The proportional valve 33BL is arranged on a pipeline connecting the operation device 26 and the corresponding shuttle valve 32BL, and is configured to be capable of changing the flow area of the pipeline. In the present embodiment, the proportional valve 33BL operates in response to a control command output by the controller 30. Therefore, regardless of an operation on the operation device 26 performed by the operator, the controller 30 can supply hydraulic oil discharged by the operation device 26, after reducing the pressure of the hydraulic oil, to the pilot port of a corresponding control valve from among the control valves 17, via the shuttle valve 32BL.

Similarly, a proportional valve 33BR functions as a control valve for machine control. The proportional valve 33BR is arranged on a pipeline connecting the operation device 26 and the corresponding shuttle valve 32BR, and is configured to be capable of changing the flow area of the pipeline. In the present embodiment, the proportional valve 33BR operates in response to a control command output by the controller 30. Therefore, regardless of an operation on the operation device 26 performed by the operator, the controller 30 can supply hydraulic oil discharged by the operation device 26, after reducing the pressure of the hydraulic oil, to the pilot port of a corresponding control valve from among the control valves 17, via the shuttle valve 32BR.

The operational pressure sensor 29B detects the operational contents with respect to the lever device 26B performed by the operator, as a pressure (operational pressure), and a detection signal corresponding to the detected pressure is taken into the controller 30. This enables the controller 30 to grasp the operational contents performed on the lever device 26B.

The controller 30 can supply hydraulic oil discharged from the pilot pump 15 to the left pilot port of the control valve 174 via the proportional valve 31BL and the shuttle valve 32BL, regardless of the bucket closing operation on the lever device 26B performed by the operator. Also, the controller 30 can supply hydraulic oil discharged from the pilot pump 15 to the right pilot port of the control valve 174 via the proportional valve 31BR and the shuttle valve 32BR, regardless of the bucket opening operation on the lever device 26B performed by the operator. In other words, the controller 30 can control opening and closing operations of the bucket 6 automatically. Also, even in the case where an operation is being performed on a particular operation device 26, the controller 30 can forcibly stop the operation of the hydraulic actuator corresponding to the particular operation device 26.

Note that in the case where the operator is performing a bucket closing operation or a bucket opening operation, operations of the proportional valves 33BL and 33BR to forcibly stop the operation of the bucket 6 are the same as the operations of the proportional valves 33AL and 33AR to forcibly stop the operation of the boom 4 in the case where the operator is performing a boom-up operation or a boom-down operation, and duplicate description is omitted.

Also, for example, as illustrated in FIG. 4C, the lever device 26C is used by the operator or the like for operating the hydraulic motor for revolution 2A corresponding to the revolving upper body 3 (revolution mechanism 2). The lever device 26C uses hydraulic oil discharged from the pilot pump 15, to output a pilot pressure corresponding to the operational contents on the secondary side.

The shuttle valve 32CL has one of the two input ports connected to a pilot line on the secondary side of the lever device 26C corresponding a revolution operation in the left direction of the revolving upper body 3 (referred to as the “leftward revolution operation”, hereafter); the other input port connected to a pilot line on the secondary side of the proportional valve 31CL; and the output port connected to the left pilot port of control valve 173.

The shuttle valve 32CR has one of the two input ports connected to a pilot line on the secondary side of the lever device 26C corresponding a revolution operation in the right direction of the revolving upper body 3 (referred to as the “rightward revolution operation”, hereafter); the other input port connected to a pilot line on the secondary side of the proportional valve 31CR; and the output port connected to the right pilot port of control valve 173.

In other words, the lever device 26C causes pilot pressures according to operational contents in the left-and-right direction to work on the pilot ports of the control valve 173 via the shuttle valves 32CL and 32CR. Specifically, in the case a leftward revolution operation is performed, the lever device 26C outputs a pilot pressure according the amount of operation to one of the input ports of the shuttle valve 32CL, to work on the left pilot port of the control valve 173 via the shuttle valve 32CL. Also, in the case a rightward revolution operation is performed, the lever device 26C outputs a pilot pressure according the amount of operation to one of the input ports of the shuttle valve 32CR, to work on the right pilot port of the control valve 173 via the shuttle valve 32CR.

The proportional valve 31CL operates in response to a control current input from the controller 30. Specifically, the proportional valve 31CL uses hydraulic oil discharged from the pilot pump 15, to output a pilot pressure according to the control current input from the controller 30, to the other pilot port of the shuttle valve 32CL. This enables the proportional valve 31CL to adjust the pilot pressure acting on the left pilot port of the control valve 173 via the shuttle valve 32CL.

The proportional valve 31CR operates in response to a control current output by the controller 30. Specifically, the proportional valve 31CR uses hydraulic oil discharged from the pilot pump 15, to output a pilot pressure according to the control current input from the controller 30, to the other pilot port of the shuttle valve 32CR. This enables the proportional valve 31CR to adjust the pilot pressure acting on the right pilot port of the control valve 173 via the shuttle valve 32CR.

In other words, the proportional valves 31CL and 31CR can adjust the pilot pressures to be output on the secondary side, so as to stop the control valve 173 at any valve position, regardless of the operational state of the lever device 26C.

Like the proportional valve 31CL, a proportional valve 33CL functions as a control valve for machine control. The proportional valve 33CL is arranged on a pipeline connecting the operation device 26 and the corresponding shuttle valve 32CL, and is configured to be capable of changing the flow area of the pipeline. In the present embodiment, the proportional valve 33CL operates in response to a control command output by the controller 30. Therefore, regardless of an operation on the operation device 26 performed by the operator, the controller 30 can supply hydraulic oil discharged by the operation device 26, after reducing the pressure of the hydraulic oil, to the pilot port of a corresponding control valve from among the control valves 17, via the shuttle valve 32CL.

Similarly, a proportional valve 33CR functions as a control valve for machine control. The proportional valve 33CR is arranged on a pipeline connecting the operation device 26 and the corresponding shuttle valve 32CR, and is configured to be capable of changing the flow area of the pipeline. In the present embodiment, the proportional valve 33CR operates in response to a control command output by the controller 30. Therefore, regardless of an operation on the operation device 26 performed by the operator, the controller 30 can supply hydraulic oil discharged by the operation device 26, after reducing the pressure of the hydraulic oil, to the pilot port of a corresponding control valve from among the control valves 17, via the shuttle valve 32CR.

The operational pressure sensor 29C detects, as a pressure, the operational state with respect to the lever device 26C performed by the operator, and a detection signal corresponding to the detected pressure is taken into the controller 30. This enables the controller 30 to grasp the operational contents performed on the lever device 26C in the left-and-right direction.

The controller 30 can supply hydraulic oil discharged from the pilot pump 15 to the left pilot port of the control valve 173 via the proportional valve 31CL and the shuttle valve 32CL, regardless of the leftward revolution operation on the lever device 26C performed by the operator. Also, the controller 30 can supply hydraulic oil discharged from the pilot pump 15 to the right pilot port of the control valve 173 via the proportional valve 31CR and the shuttle valve 32CR, regardless of the rightward revolution operation on the lever device 26C performed by the operator. In other words, the controller 30 can control a revolution operation of the revolving upper body 3 in the left-and-right direction automatically. Also, even in the case where an operation is being performed on a particular operation device 26, the controller 30 can forcibly stop the operation of the hydraulic actuator corresponding to the particular operation device 26.

Note that in the case where the operator is performing a revolution operation, operations of the proportional valves 33CL and 33CR to forcibly stop the operation of the revolving upper body 3 are the same as the operations of the proportional valves 33AL and 33AR to forcibly stop the operation of the boom 4 in the case where the operator is performing a boom-up operation or a boom-down operation, and duplicate description is omitted.

Note that the excavator 100 may further be provided with an element for automatically opening or closing the arm 5, and an element for automatically driving the traveling lower body 1 forward or backward. In this case, in the hydraulic system, part of the elements related to the operation system of the arm cylinder 8, part of the elements related to the operation system of the hydraulic motor for traveling 1L, and part of the elements related to the operation system of the hydraulic motor for traveling 1R may be configured in substantially the same way as the part of the elements related to the operation system of the boom cylinder 7 (FIGS. 4A to 4C).

### [Details of Configuration Related to Function of Detecting Load of Earth and Sand of the Excavator]

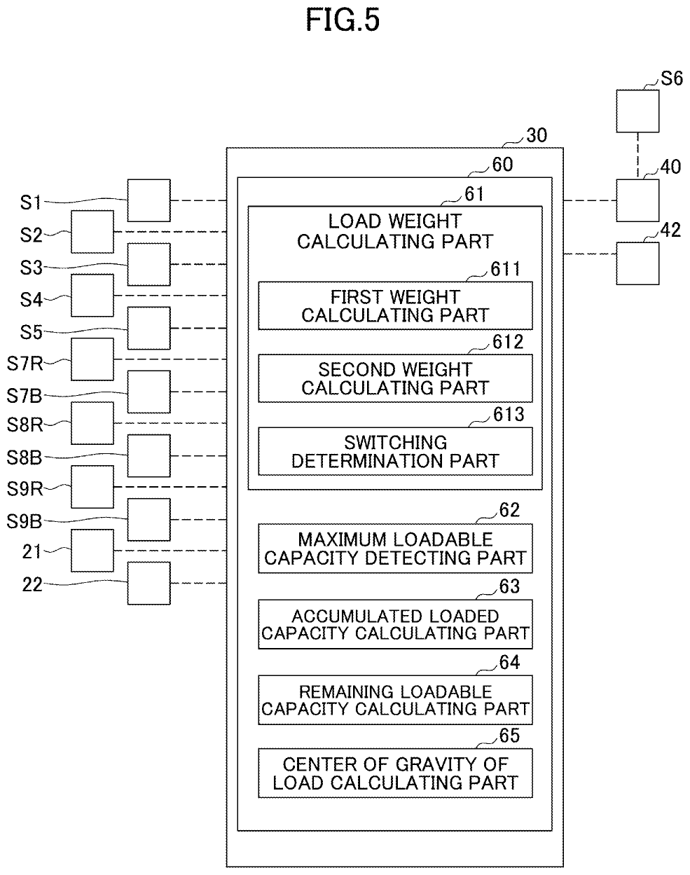

Next, with reference to FIG. 5, details of a configuration of a function of detecting load of earth and sand of the excavator 100 according to the present embodiment will be described. FIG. 5 is a diagram schematically illustrating an example of part of the configuration related to the function of detecting load of earth and sand of the excavator 100 according to the present embodiment.

As described earlier with reference to FIG. 3, the controller 30 includes the earth and sand load processing part 60 that serves as a functional part related the function of detecting the load of earth and sand excavated with the bucket 6.

The earth and sand load processing part 60 includes a load weight calculating part 61, a maximum loadable capacity detecting part 62, an accumulated load capacity calculating part 63, a remaining loadable capacity calculating part 64, and a center of gravity of load calculating part 65.

Here, an example of operations of loading work of earth and sand (loaded matter) onto a dump truck DT by the excavator 100 according to the present embodiment will be described.

First, the excavator 100 controls an attachment to excavate earth and sand by using the bucket 6 at an excavation position (excavation operation). Next, the excavator 100 revolves the revolving upper body 3, and moves the bucket 6 from the excavation position to a soil release position (revolution operation). The bed of the dump truck DT is arranged below the soil release position. Next, by controlling the attachment at the soil release position to discharge the earth and sand in the bucket 6, the excavator 100 loads the earth and sand in the bucket 6 onto the bed of the dump truck DT (earth and sand-discharging operation). Next, the excavator 100 revolves the revolving upper body 3, and moves the bucket 6 from the soil release position to the excavation position (revolution operation). By repeating these operations, the excavator 100 loads the excavated earth and sand onto the bed of the dump truck DT.

The load weight calculating part 61 calculates the weight of the earth and sand (loaded matter) in the bucket 6. The load weight calculating part 61 includes a first weight calculating part 611, a second weight calculating part 612, and a switching determination part 613.

The first weight calculating part 611 calculates the weight of the earth and sand, based on the thrust of the boom cylinder 7. The second weight calculating part 612 calculates the weight of the earth and sand, based on the thrust of the bucket cylinder 9. Note that the methods of calculating the weight of earth and sand in the first weight calculating part 611 and the second weight calculating part 612 will be described later.

The switching determination part 613 switches the weight of the earth and sand to be output by the load weight calculating part 61, by determining whether to adopt the weight of the earth and sand to be calculated by the first weight calculating part 611, or to adopt the weight of the earth and sand to be calculated by the second weight calculating part 612.

Note that the load weight calculating part 61 may be configured to cause both the first weight calculating part 611 and the second weight calculating part 612 to calculate the respective weights of the earth and sand, and cause the switching determination part 613 to determine which one of the weights of the earth and sand from among the calculated two weights of the earth and sand, is to be output from the load weight calculating part 61, to execute switching.

Alternatively, the load weight calculating part 61 may be configured to execute switching by causing the switching determination part 613 to determine the weight calculating part to calculate the weight of the earth and sand, in other words, by causing one of the weight calculating parts from among the first weight calculating part 611 and the second weight calculating part 612 to execute processing, and causing the other weight calculating part to stop processing. Alternatively, the load weight calculating part 61 may also be configured to cause the first weight calculating part 611 to calculate the weight of the earth and sand all the times, regardless of the determination by the switching determination part 613, and to cause the second weight calculating part 612 to calculate the weight of the earth and sand only when selected by the switching determination part 613.

The switching determination part 613 executes switching between the first weight calculating part 611 and the second weight calculating part 612, depending on the state of the boom cylinder 7 that drives the boom 4. For example, the switching determination part 613 normally causes the first weight calculating part 611 to calculate the weight of the earth and sand, and if a predetermined condition is satisfied, switches the calculation of the weight of the earth and sand to the second weight calculating part 612. Also, once the predetermined condition is no longer unsatisfied, the switching determination part 613 switches again the calculation of the weight of the earth and sand to the first weight calculating part 611.

Here, the predetermined condition may be, for example, a timing of the start of or a timing of the end of an operation of raising the boom 4. For example, the switching determination part 613 determines whether it is a timing of the start of or a timing of the end of an operation of raising the boom 4, based on a detected value of the boom angle sensor S1 (position sensor). If it is a timing of the start of or a timing of the end of an operation of raising the boom 4, the switching determination part 613 selects the second weight calculating part 612. If it is not a timing of the start of or a timing of the end of an operation of raising the boom 4, the switching determination part 613 selects the first weight calculating part 611. Note that the method of detecting a timing of the start of or a timing of the end of an operation of raising the boom 4 is not limited as such a method; the detection may be done by a sensor (not illustrated) to detect an input on the operation device 26, or may be done by a sensor (not illustrated) to detect the pilot pressure. Also, the predetermined condition is not limited to a timing of the start of or a timing of the end of an operation of raising the boom 4. For example, the condition may be occurrence of oscillation in time in the value of the weight of the earth and sand calculated by the first weight calculating part 611.

The first weight calculating part 611 calculates the weight of the earth and sand, based on the thrust of the boom cylinder 7. For example, the first weight calculating part 611 calculates the weight of the earth and sand, based on the thrust of the boom cylinder 7; a distance from a pin that couples the revolving upper body 3 to the boom 4 to the center of gravity of the earth and sand; and an equation of the moment around the pin that couples the revolving upper body 3 to the boom 4. Also, the second weight calculating part 612 calculates the weight of the earth and sand, based on the thrust of the bucket cylinder 9. For example, the second weight calculating part 612 calculates the weight of the earth and sand, based on the thrust of the bucket cylinder 9; a distance from a pin that couples the arm 5 to the bucket 6 to the center of gravity of the earth and sand; and an equation of the moment around the pin that couples the arm 5 to the bucket 6.

Here, the distance from the pin that couples the revolving upper body 3 to the boom 4 to the center of gravity of the earth and sand is longer than the distance from the pin that couples the arm 5 to the bucket 6 to the center of gravity of the earth and sand. Therefore, for example, with respect to the deviation of the position of the estimated position of the center of gravity of earth and sand from the actual position of the center of gravity of the earth and sand, the distance from the pin that couples the revolving upper body 3 to the boom 4 to the center of gravity of the earth and sand, is less affected by the positional deviation than the distance from the pin that couples the arm 5 to the bucket 6 to the center of gravity of the earth and sand. Therefore, the first weight calculating part 611 can calculate the weight of the earth and sand more precisely than the second weight calculating part 612.

However, for example, at a timing of the start of an operation of raising the boom 4 and at a timing of the end of an operation of raising the boom 4, oscillation occurs in the thrust of the boom cylinder 7, and thereby, oscillation also occurs in the weight of the earth and sand calculated by the first weight calculating part 611. Therefore, it becomes difficult for the first weight calculating part 611 to detect the weight of the earth and sand precisely. In this case, the switching determination part 613 switches the calculation of the weight of the earth and sand to the second weight calculating part 612. In this way, even at a timing of the start of an operation of raising the boom 4 and at a timing of the end of an operation of raising the boom 4, the weight of the earth and sand can be calculated while maintaining the precision.

Note that although the description assumes that the second weight calculating part 612 calculates the weight of the earth and sand, based on the thrust of the bucket cylinder 9, it is not limited as such. The second weight calculating part 612 may calculate the weight of the earth and sand, based on the thrust of the arm cylinder 8. For example, the second weight calculating part 612 may calculate the weight of the earth and sand, based on the thrust of the arm cylinder 8; the distance from a pin that couples the boom 4 to the arm 5, to the center of gravity of the earth and sand; and the equation of the moment around the pin that couples the boom 4 to the arm 5.

Note that in the present embodiment, although an example has been described in which the switching determination part 613 switches the weight of the earth and sand to be output by the load weight calculating part 61, by determining whether to adopt the weight of the earth and sand to be calculated by the first weight calculating part 611, or to adopt the weight of the earth and sand to be calculated by the second weight calculating part 612, the load weight calculating part 61 is not limited as such. The load weight calculating part 61 may calculate the weight of the earth and sand, based on the thrust of the bucket cylinder 9, by using only the second weight calculating part 612. In the case of using the first weight calculating part 611 to calculate the weight of the earth and sand, based on the thrust of the boom cylinder 7, parameters such as the weight of the attachment need to be taken into account, and the precision may be reduced. In contrast, by calculating the weight of the earth and sand, based on the thrust of the bucket cylinder 9, by using only the second weight calculating part 612, the number of parameters to be taken into account can be reduced, and the precision of calculation of the weight of the earth and sand can be improved.

The maximum loadable capacity detecting part 62 detects the maximum loadable capacity of the dump truck DT to be loaded with earth and sand. For example, the maximum loadable capacity detecting part 62 identifies the dump truck DT, based on images captured by the imaging device S6. Next, the maximum loadable capacity detecting part 62 detects the maximum loadable capacity of the dump truck DT, based on images of the identified dump truck DT.

For example, the maximum loadable capacity detecting part 62 determines the type (size etc.) of the dump truck DT based on an image of the identified dump truck DT. The maximum loadable capacity detecting part 62 has a table in which a vehicle type is associated with a maximum loadable capacity, and based on the vehicle type determined from the image and the table, determines the maximum loadable capacity of the dump truck DT. Note that the maximum loadable capacity detecting part 62 may receive as input through the input device 42, the maximum loadable capacity, the vehicle type, and the like of the dump truck DT, to determine the maximum loadable capacity of the dump truck DT based on the input information from the input device 42.

The accumulated load capacity calculating part 63 calculates the weight of the earth and sand loaded onto the dump truck DT. In other words, every time earth and sand in the bucket 6 is discharged onto the bed of the dump truck DT, the accumulated load capacity calculating part 63 accumulates the weight of the earth and sand in the bucket 6 calculated by the load weight calculating part 61, to calculate the accumulated load capacity (total weight) as the total weight of earth and sand loaded on the bed of the dump truck DT. Note that in the case where the dump truck DT to be loaded with earth and sand is replaced with a new dump truck DT, the accumulated load capacity is reset.

The remaining loadable capacity calculating part 64 calculates, as the remaining loadable capacity, difference between the maximum loadable capacity of the dump truck DT detected by the maximum loadable capacity detecting part 62, and the current accumulated load capacity calculated by the accumulated load capacity calculating part 63. The remaining loadable capacity is the remaining loadable weight of earth and sand that can be loaded on the dump truck DT.

The center of gravity of load calculating part 65 calculates the center of gravity of the earth and sand (loaded matter) in the bucket 6. Note that the method of calculating the center of gravity of the earth and sand will be described later.

The display device 40 may display the weight of the earth and sand in the bucket 6 calculated by the load weight calculating part 61, the maximum loadable capacity of the dump truck DT detected by the maximum loadable capacity detecting part 62, the accumulated load capacity of the dump truck DT calculated by the accumulated load capacity calculating part 63 (the total weight of earth and sand loaded on the bed), and the remaining loadable capacity of the dump truck DT calculated by the remaining loadable capacity calculating part 64 (the remaining loadable weight of earth and sand).

Note that the display device 40 may be configured to issue a warning in the case where the accumulated load capacity exceeds the maximum loadable capacity. Also, the display device 40 may be configured to issue a warning in the case where the calculated weight of the earth and sand in the bucket 6 exceeds the remaining loadable capacity. Note that the warning is not limited to a form of being displayed on the display device 40, and may be a sound output by the sound output device 43. This makes it possible to prevent earth and sand from being loaded in excess of the maximum loadable capacity of the dump truck DT.

### [Method of Calculating the Weight of Earth and Sand in the First Weight Calculating Part 611]

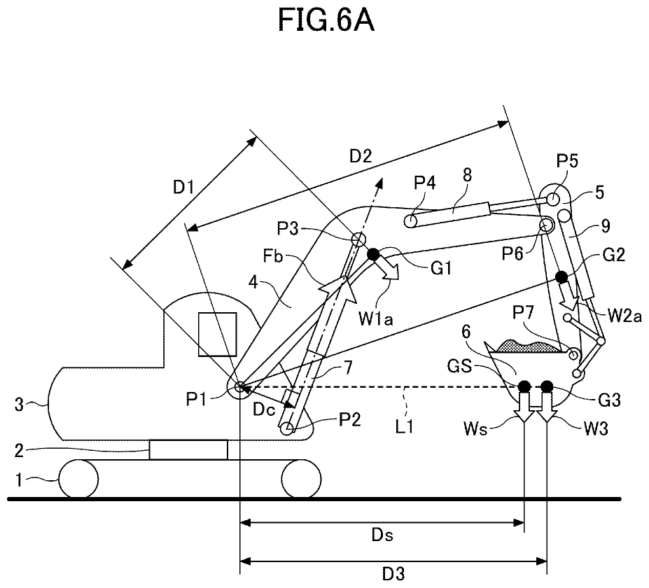

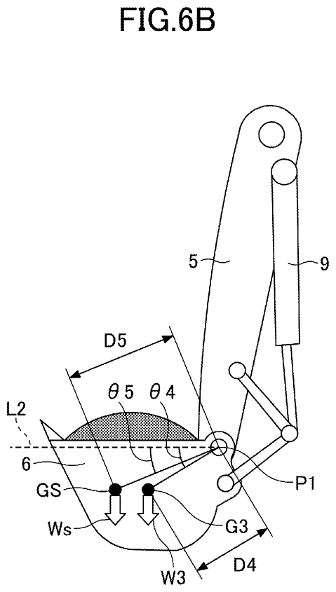

Next, with reference to FIG. 5, by using FIGS. 6A-6B, a method of calculating the weight of the earth and sand in the bucket 6 (loaded matter) executed by the first weight calculating part 611 of the excavator 100 according to the present embodiment will be described.

FIGS. 6A and 6B are schematic diagrams illustrating parameters for calculation of the weight of the earth and sand in an attachment of the excavator 100. FIG. 6A illustrates the excavator 100, and FIG. 6B illustrates the vicinity of the bucket 6. Assume that in the following description, a pin P1 that will be described later, the center of gravity of the bucket G3, and the center of gravity of the earth and sand Gs are located on a horizontal line L1.

Here, a pin connecting the revolving upper body 3 and the boom 4 is denoted as P1. A pin connecting the revolving upper body 3 and the boom cylinder 7 is denoted as P2. A pin connecting the boom 4 and the boom cylinder 7 is denoted as P3. A pin connecting the boom 4 and the arm cylinder 8 is denoted as P4. A pin connecting the arm 5 and the arm cylinder 8 is denoted as P5. A pin connecting the boom 4 and the arm 5 is denoted as P6. A pin connecting the arm 5 and the bucket 6 is denoted as P7. Also, the center of gravity of the boom 4 is denoted as G1. The center of gravity of the arm 5 is denoted as G2. The center of gravity of the bucket 6 is denoted as G3. The center of gravity of the earth and sand (loaded latter) loaded in the bucket 6 is denoted as Gs. Assume that a reference line L2 passes through the pin P7 and is parallel to the opening face of the bucket 6. Also, the distance between the pin P1 and the center of gravity G4 of the boom 4 is denoted as D1. The distance between the pin P1 and the center of gravity G5 of the arm 5 is denoted as D2. The distance between the pin P1 and the center of gravity G6 of the bucket 6 is denoted as D3. The distance between the pin P1 and the center of gravity of the earth and sand Gs is denoted as Ds. The distance between a line connecting the pins P2 and P3, and the pin P1 is denoted as Dc. Also, a detected value of the cylinder pressure of the boom cylinder 7 is denoted as Fb. Also, in the weight of the boom, the vertical component in a direction perpendicular to the line connecting pin P1 and the center of gravity of the boom G1 is denoted as W1a. In the weight of the arm, the vertical component in a direction perpendicular to the line connecting pin P1 and the center of gravity of the arm G2 is denoted as W2a. The weight of the bucket 6 is denoted as W6, and the weight of the earth and sand (loaded matter) loaded in the bucket 6 is denoted as Ws.

As illustrated in FIG. 6A, the position of the pin P7 is calculated with the boom angle and the arm angle. In other words, the position of the pin P7 can be calculated based on detected values of the boom angle sensor S1 and the arm angle sensor S2.

Also, as illustrated in FIG. 6B, the positional relationship between the pin P7 and the center of gravity of the bucket G3 (where θ4 represents an angle formed by the reference line L2 of the bucket 6 and the straight line connecting the pin P7 and the center of gravity of the bucket G3; and D4 is a distance between the pin P7 and the center of gravity of the bucket G3) is a default value. Also, the positional relationship between the pin P7 and the center of gravity of the earth and sand Gs (θ5 is an angle formed by the reference line L2 of the bucket 6 and the straight line connecting the pin P7 and the center of gravity of the earth and sand Gs; and D5 is a distance between the pin P7 and the center of gravity of the earth and sand Gs) is determined, for example, experimentally in advance, and stored in the controller 30. In other words, based on the bucket angle sensor S3, the center of gravity of the earth and sand Gs and the center of gravity of the bucket G3 can be estimated.

In other words, the center of gravity of load calculating part 65 can estimate the center of gravity of the earth and sand Gs, based on the detected values of the boom angle sensor S1, the arm angle sensor S2, and the bucket angle sensor S3.

Next, a formula of the balance involving each moment around the pin P1 and the boom cylinder 7 can be expressed by the following formula (A1).

WsDs+W1aD1+W2aD2+W3D3=FbDc (A1)

Formula (1) can be expressed by the following formula (A2) with respect to the weight of the earth and sand Ws.

Ws=(FbDc−(W1aD1+W2aD2+W3D3))/Ds (A2)

Here, the detected value Fb of the cylinder pressure of the boom cylinder 7 is calculated with the boom rod pressure sensor S7R and the boom bottom pressure sensor S7B. The distance Dc and the vertical component W1a of the weight are calculated by the boom angle sensor S1. The vertical component W2a of the weight and the distance D2 are calculated with the boom angle sensor S1 and the arm angle sensor S2. The distance D1 and the weight W3 are known values. Also, by estimating the center of gravity of the earth and sand Gs and the center of gravity of the bucket G3, the distance Ds and the distance D3 can also be estimated.

Therefore, the weight of the earth and sand Ws can be calculated based on a detected value of the cylinder pressure of the boom cylinder 7 (detected values of the boom rod pressure sensor S7R and the boom bottom pressure sensor S7B), a boom angle (a detected value of the boom angle sensor S1), and an arm angle (a detected value of the arm angle sensor S2). This enables the load weight calculating part 61 to calculate the weight of the earth and sand Ws, based on the center of gravity of the earth and sand Gs estimated by the center of gravity of load calculating part 65.

Note that whether or not the excavator 100 is under a default operation can be determined by estimating the position of the attachment based on the detected value of the pilot of bucket cylinder 9.

Note that in the above description, although the center of gravity of the earth and sand is estimated, and the weight of the earth and sand is calculated, regarding the position of the bucket 6 in the default operation as horizontal, the process is not limited as such. For example, the position of the bucket 6 may be estimated based on an image of the bucket 6 captured by the camera S6F that captures a front image. Also, in the case where the bucket 6 is captured in an image by the camera S6F, if it is determined based on the image that the position of the bucket 6 is horizontal, estimation of the center of gravity of the earth and sand and calculation of the load of earth and sand may be executed.

### [Method of Calculating the Weight of Earth and Sand in the Second Weight Calculating Part 612]

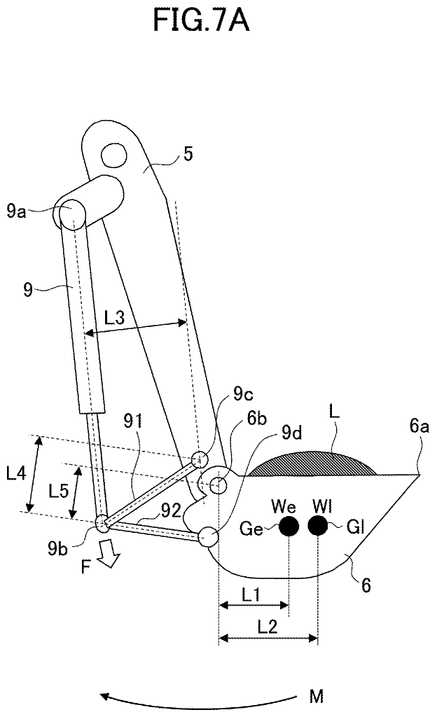

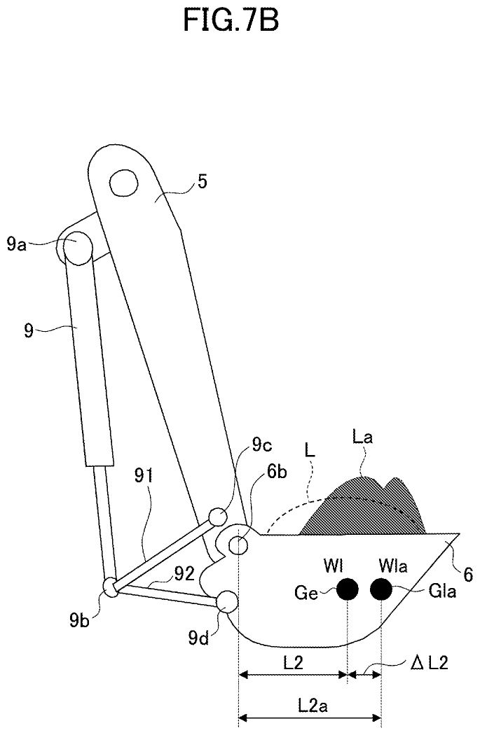

Next, with reference to FIG. 5, by using FIGS. 7A-7B, a method of calculating the weight of the earth and sand in the bucket 6 (loaded matter) executed by the second weight calculating part 612 of the excavator 100 according to the present embodiment will be described.

FIG. 7A or 7B is a partially enlarged view illustrating a relationship of forces acting on the bucket 6. Also, FIG. 7A illustrates a case where the shape of the earth and sand in the bucket 6 is a first shape (reference shape). FIG. 7B illustrates a case where the shape of the earth and sand in the bucket 6 is a second shape (an example of the shape when measuring the weight of the earth and sand).

As illustrated in FIG. 7A, the rear end of the bucket cylinder 9 is coupled to the vicinity of the rear end of the arm 5 by a coupling pin 9a. The front end of the bucket cylinder 9 is coupled to the respective ends of the two links 91 and 92, by a coupling pin 9b. The link 91 has its one end coupled to the front end of the bucket cylinder 9 by the coupling pin 9b, and has the other end coupled to the vicinity of the front end of the arm 5 by the coupling pin 9c. The link 92 has its one end coupled to the front end of the bucket cylinder 9 by the coupling pin 9b, and has the other end coupled to the vicinity of the base end of the bucket 6 by the coupling pin 9d.

Also, as illustrated in FIG. 7A, L1 represents the horizontal distance between the center of gravity Ge of the bucket 6 and the center of the bucket support shaft 6b. L2 represents the horizontal distance between the center of gravity G1 of the earth and sand L in the bucket 6, and the center of the bucket support shaft 6b. L3 represents the distance between a line segment passing through the center of the coupling pin 9a (the center axis of the bucket cylinder 9) and the center of the coupling pin 9b, and the center of the coupling pin 9c. L4 represents the distance between a line segment passing through the center of the coupling pin 9b and the center of the coupling pin 9d (the center axis of the link 92), and the center of the coupling pin 9c. L5 represents the distance between a line segment passing through the center of the coupling pin 9b and the center of the coupling pin 9d (the center axis of the link 92) and the center of the bucket support shaft 6b.

In the case where the bucket 6 of the excavator 100 is maintained in a predetermine load holding position regardless of the tilt angle of the arm 5, for example, the bucket front end 6a is maintained in a predetermined horizontal position to be located at the same height as the bucket support shaft 6b, two moments act around the bucket support shaft 6b: a moment M due to the weight on the bucket 6 side; and a moment due to the reaction force F of the bucket cylinder 9 that maintains the bucket 6 in the load holding position. The bucket 6 is balanced in this state; therefore, the balancing conditions causes the two moments to have the directions opposite to each other, and to be equal in magnitude.

The moment M due to the weight on the bucket 6 side can be divided into a moment Me due to the empty weight We of the bucket 6 and a moment Ml due to the weight W1 of the earth and sand L; therefore, the moment M can be expressed by the following formula (1).

M=Me+M1 (1)

Next, the moment due to the reaction force F of the bucket cylinder 9 that maintains the bucket 6 in the load holding position will be described. First, denoting as mc the moment around the center of the coupling pin 9c of the link 91 imparted by the reaction force F of the bucket cylinder 9, mc can be expressed by the following formula (2-1):

mc=F·L3 (2-1)

Meanwhile, the link 91 is rotatably coupled to the link 92 at the center of the coupling pin 9b; denoting as fbd the reaction force acting in the direction from the coupling pin 9b of the link 92 to the coupling pin 9d, from the balance with the moment mc around the center of the coupling pin 9c, fbd can be expressed by the following formula (2-2):

fbd·L4=mc (2-2)

Further, at the center of the bucket support shaft 6b, the moment M of the bucket 6 is balanced with the reaction force fcd acting at the center of coupling pin 9d; therefore, fcd can be expressed by the following formula (2-3):

fcd·L5=M (2-3)

By rewriting formulas (2-1) to (2-3), a formula of the balance can be expressed by the following formula (2):

F·L3·L5/L4=M (2)

Here, in the case where the bucket 6 is maintained in the predetermined load holding position, the positions of the coupling pins 9a to 9d with respect to the position of the bucket support shaft 6b can be determined uniquely by the position sensors (for example, the boom angle sensor S1, the arm angle sensor S2, the bucket angle sensor S3, the machine tilt sensor S4, and the revolution state sensor S5), and thereby, the distances L3, L4, and L5 can be determined.

Also, denoting as P the load pressure detected based on the pressure sensors (for example, the bucket rod pressure sensor S9R and the bucket bottom pressure sensor S9B) of the bucket cylinder 9, and denoting as S the pressure receiving area of the piston of the bucket cylinder 9, the reaction force F of the bucket cylinder 9 can be expressed by the following formula (3):

F=P×S (3)

As described above, based on the detected values of the position sensors and the pressure sensors of the bucket cylinder 9, from formulas (2) and (3), the moment due to the reaction force F of the bucket cylinder 9 can be determined.

Meanwhile, the moment Me by the empty weight We of the bucket 6 can be expressed by the following formula (4), and the moment Ml by the weight W1 of the earth and sand L can be expressed by the following formula (5):

Me=We×L1 (4)

M1=W1×L2 (5)

Note that in the case where the bucket 6 is maintained in the predetermined load holding position, the distance L1 can be determined by the position sensors. Note that the distance L2 is determined, for example, experimentally in advance, and is stored in the controller 30. Alternatively, the distance L2 may be determined based on the center of gravity of the earth and sand calculated by the center of gravity of load calculating part 65 that will be described later.

As described above, based on the detected values of the position sensors and the pressure sensors of the bucket cylinder 9, from formulas (1) and (5), the weight W1 of the earth and sand L can be determined. Note that although it has been described that the weight of the earth and sand is calculated based on the pressure of the bucket cylinder 9, it is not limited as such. For example, the weight W1 of the earth and sand L may be determined based on the detected values of the position sensors and the pressure sensors of the boom cylinder 7. Also, the weight W1 of the earth and sand L may be determined based on the detected values of the position sensors and the pressure sensors of the arm cylinder 8. Note that the relational expressions in these cases can be determined in substantially the same way, and the description is omitted.

Here, when performing an excavation operation by using the excavator 100, earth and sand enter the bucket 6 staring from the bucket front end 6a. Depending on the skill of the operator, the shape of the earth and sand L in the bucket 6 does not necessarily have a shape as in the case of being evenly loaded in the bucket 6 as illustrated in FIG. 7A. For example, as illustrated in FIG. 7B, the shape of the earth and sand La in the bucket 6 may be shifted to the side of the bucket front end 6a and different from the reference shape. In this case, the position of the center of gravity G1a of the earth and sand La in the bucket 6 may be different from the position of the center of gravity G1 of the earth and sand L of the reference shape illustrated in FIG. 7A.

Referring back to FIG. 5, the center of gravity of load calculating part 65 has a function of calculating the position of the center of gravity of the earth and sand loaded in the bucket 6. The center of gravity of load calculating part 65 calculates the position of the center of gravity of the earth and sand by using, for example, one of the first to fourth estimation methods of the center of gravity.

### (First Method of Calculating Center of Gravity)

The first method of calculating center of gravity by the center of gravity of load calculating part 65 will be described. The imaging device S6 captures an image of the shape of the earth and sand loaded on the bucket 6. The center of gravity of load calculating part 65 obtains the image captured by the imaging device S6. The center of gravity of load calculating part 65 calculates the position of the center of gravity of the earth and sand, based on the shape of the earth and sand in the image captured by the imaging device S6.

Here, the center of gravity of load calculating part 65 has information on the shape of the inside surfaces of the bucket 6. The center of gravity of load calculating part 65 estimates an overall shape of the earth and sand loaded on the bucket 6, based on the shape of the earth and sand in the image captured by the imaging device S6, and the information on the shape of the inside surfaces of the bucket 6 registered in advance. The center of gravity of load calculating part 65 calculates the position of the center of gravity of the earth and sand, based on the shape of the entirety of the estimated earth and sand. For example, the center of gravity of load calculating part 65 calculates the position of the center of gravity of the earth and sand, assuming that the density distribution of the earth and sand is uniform, based on the estimated overall shape of the earth and sand.

Note that as the imaging device S6 that captures an image of the shape of the earth and sand loaded on the bucket 6, for example, the camera S6F that captures an image in front of the excavator 100 may be used. Alternatively, a camera (not illustrated) that captures an image of the shape of the earth and sand may be provided on the boom 4 or the arm 5. By providing the imaging device on the boom 4 or the arm 5, images can be captured from above the earth and sand; therefore, the shape of the earth and sand can be estimated more precisely. Also, these cameras may be, for example, stereo cameras.

### (Second Method of Calculating Center of Gravity)

The second method of calculating center of gravity by the center of gravity of load calculating part 65 will be described. Before starting an excavation operation by using the excavator 100, the operator operates the input device 42, to select parameters. As the parameters (information on characteristics of earth and sand), for example, the type of earth and sand (e.g., soil, sand, gravel, etc.), the state (e.g., a wet state, dry state, etc.) of the earth and sand of the excavation target are entered. The center of gravity of load calculating part 65 calculates the position of the center of gravity of the earth and sand, based on at least one of the entered type and state of the earth and sand.

Here, the angle of rest varies depending on the type and state of the earth and sand. Therefore, in the case of excavating earth and sand by the bucket 6 to set the position of the bucket 6 to a position of estimating the weight of the earth and sand (load holding position), the shape of the top surface of the earth and sand loaded on the bucket 6 can be estimated by using the type and state of the earth and sand, the parameters (information on characteristics of earth and sand), and the like. The center of gravity of load calculating part 65 estimates an overall shape of the earth and sand loaded on the bucket 6, based on the estimated shape of the top surface of the earth and sand and the information on the shape of the inside surfaces of the bucket 6. Also, the center of gravity of load calculating part 65 calculates the position of the center of gravity of the earth and sand, based on the shape of the entirety of the estimated earth and sand.

Note that a table in which the position of the center of gravity of earth and sand loaded in the bucket 6 is associated with the parameters of the earth and sand (information on characteristics of earth and sand: type, state, etc.), may be stored in advance in the center of gravity of load calculating part 65. In this case, the center of gravity of load calculating part 65 can calculate the position of the center of gravity of the earth and sand, based on the entered parameters and the table. Note that the table may be determined by an experiment, a simulation, or the like.

### (Third Method of Calculating Center of Gravity)

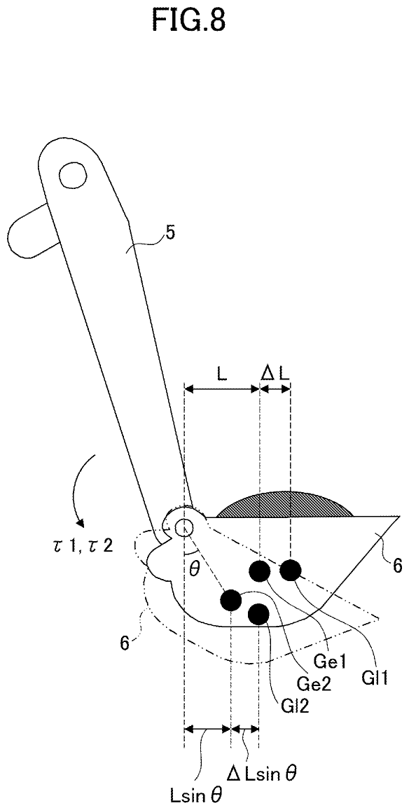

A third method of calculating center of gravity by the center of gravity of load calculating part 65 will be described with reference to FIG. 8. FIG. 8 is a schematic diagram illustrating the third method of calculating center of gravity executed by the center of gravity of load calculating part 65.

The center of gravity of load calculating part 65 calculates the position of the center of gravity of the earth and sand, based on the cylinder pressure of the bucket cylinder 9 when the bucket 6 is set to a first state, and the cylinder pressure of the bucket cylinder 9 when the bucket 6 is set to a second state.

First, the controller 30 sets the bucket 6 into the first state (as indicated by solid lines in FIG. 8). In the example illustrated in FIG. 8, the bucket 6 is set to have a position such that the opening surface becomes horizontal. Here, the center of gravity of the bucket 6 in the first state is denoted as Ge1, and the center of gravity of the earth and sand in the first state is denoted as G11. The horizontal distance from the bucket support shaft 6b to center of gravity Ge1 is denoted as L; and the horizontal distance from the bucket support shaft 6b to center of gravity G11 is denoted as L+ΔL. Also, the weight of the earth and sand is denoted as W.

In the first state, torque τ1 due to the weight of the earth and sand acting on the bucket support shaft 6b can be expressed by the following formula (6):

τ1=W(L+ΔL) (6)

Next, the controller 30 sets the bucket 6 into the second state (as indicated by two-dot chain lines in FIG. 8). In the example illustrated in FIG. 8, the angle of the bucket is opened by θ from the first state. Here, the center of gravity of the bucket 6 in the second state is denoted as Ge2, and the center of gravity of the earth and sand in the second state is denoted as G12. In this case, the horizontal distance from the bucket support shaft 6b to center of gravity Ge2 becomes L sin θ, and the horizontal distance from the bucket support shaft 6b to center of gravity G12 becomes L sin θ+ΔL sin θ.

In the second state, torque τ2 due to the weight of the earth and sand acting on the bucket support shaft 6b can be expressed by the following formula (7):

τ2=W(L sin θ+ΔL sin θ) (7)

In formulas (6) and (7), the weight of the earth and sand W is the same, and hence, formula (8) is derived as follows:

τ1/(L+ΔL)=τ2/(L sin θ+ΔL sin θ) (8)

Here, the torque τ1 and the torque τ2 can be determined by the cylinder pressures of the bucket cylinder 9 (the bucket rod pressure sensor S9R and the bucket bottom pressure sensor S9B) and the position sensors (the bucket angle sensor S3). Also, the angle θ can be determined by the bucket angle sensor S3. Also, the center of gravity Ge2 of the bucket 6 has been determined in advance, and the distance L is also a known value. The center of gravity of load calculating part 65 can calculate the position of the center of gravity of the earth and sand, based on these values and formula (8).

### (Fourth Method of Calculating Center of Gravity)

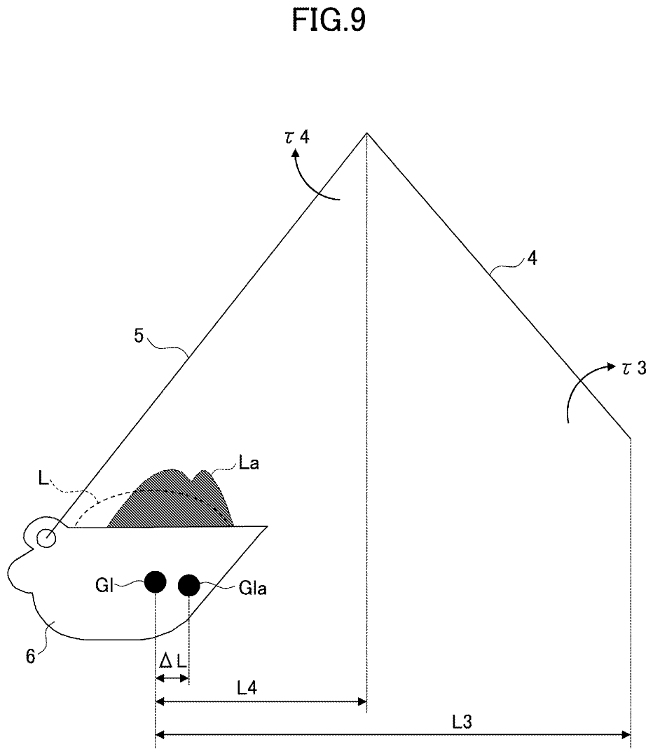

A fourth method of calculating center of gravity by the center of gravity of load calculating part 65 will be described with reference to FIG. 9. FIG. 9 is a schematic diagram illustrating the fourth method of calculating center of gravity executed by the center of gravity of load calculating part 65.

The center of gravity of load calculating part 65 calculates the position of the center of gravity of the earth and sand, based on at least two of the pressure of the boom cylinder 7, the pressure of the arm cylinder 8, and the pressure of the bucket cylinder 9.

First, the controller 30 sets the attachment to a predetermined state. In the example illustrated in FIG. 9, the bucket 6 is set to have a position such that the opening surface becomes horizontal. Here, the center of gravity of the earth and sand L is denoted as G1 and the actual center of gravity of earth and sand La is denoted as G1a. The horizontal distance from the boom support shaft that couples the revolving upper body 3 with the boom 4 to the center of gravity G1 is denoted as L3; the horizontal distance from the arm support shaft that couples the boom 4 with the arm 5 to the center of gravity G1 is denoted as L4; and the horizontal distance between the center of gravity G1 and the center of gravity G1a is denoted as ΔL. Also, the weight of the earth and sand is denoted as W.

Torque τ3 due to the weight of the earth and sand acting on the boom support shaft can be expressed by the following formula (9), and torque τ4 due to the weight of the earth and sand acting on the arm support shaft can be expressed by the following formula (10):

τ3=W(L3−ΔL) (9)

τ4=W(L4−ΔL) (10)

In formulas (9) and (10), the weight of the earth and sand W is the same, and hence, formula (11) is derived as follows:

τ3/(L3−ΔL)=τ4/(L4−ΔL) (11)

Here, the torque τ3 can be determined by the cylinder pressures of the boom cylinder 7 (the boom rod pressure sensor S7R and the boom bottom pressure sensor S7B) and the position sensors (the boom angle sensor S1, the arm angle sensor S2, and the bucket angle sensor S3). The torque τ4 can be determined by the cylinder pressures of the arm cylinder 8 (the arm rod pressure sensor S8R and the arm bottom pressure sensor S8B) and the position sensors (the boom angle sensor S1, the arm angle sensor S2, and the bucket angle sensor S3). The center of gravity G1 is a value that has been set in advance, and the distances L3 and L4 can be obtained by the position sensors (the boom angle sensor S1, the arm angle sensor S2, and the bucket angle sensor S3). The center of gravity of load calculating part 65 can calculate the distance ΔL based on these values and formula (11). In other words, the center of gravity of load calculating part 65 can calculate the position of the center of gravity L1a of the earth and sand La.

Note that although an example has been described for the case of calculating the position of center of gravity of the earth and sand, based on the pressure of the boom cylinder 7 and the pressure of the arm cylinder 8, it is not limited as such. For example, the position of center of gravity of the earth and sand may be calculated, based on the pressure of the boom cylinder 7 and the pressure of the bucket cylinder 9. Alternatively, the position of center of gravity of the earth and sand may be calculated, based on the pressure of the arm cylinder 8 and the pressure of the bucket cylinder 9. Note that the relational expressions in these cases can be determined in substantially the same way, and the description is omitted.

As described above, according to the excavator 100 in the present embodiment, the excavated weight of earth and sand can be detected. Also, according to the excavator 100 in the present embodiment, the center of gravity of the earth and sand can be calculated by the center of gravity of load calculating part 65, and the weight of the earth and sand can be calculated based on the calculated center of gravity of the earth and sand. In this way, for example, even in the case where the earth and sand loaded is shifted on the bucket 6, the weight of the earth and sand can be calculated based on the center of gravity of the earth and sand, and the detection precision of the weight of the earth and sand can be improved.

Also, the excavator 100 can calculate the weight of the earth and sand loaded onto the dump truck DT. This can prevent overload on the dump truck DT. For example, the load of the dump truck DT is checked by a truck scale or the like before leaving the working site to a public road. In the case where the load exceeds the maximum loadable capacity, the dump truck DT needs to return to the position of the excavator 100, and to reduce the amount of earth and sand. Therefore, the operational efficiency of the dump truck DT declines. Also, underloading of the dump truck DT increases the total number of dump trucks DT transporting earth and sand, and reduces the operational efficiency of the dump truck DT. In contrast, according to the excavator 100 in the present embodiment, earth and sand can be loaded on the dump truck DT while preventing overload, and thereby, the operational efficiency of the dump truck DT can be improved.

Also, on the display device 40, the weight of the earth and sand in the bucket 6, the maximum loadable capacity, the accumulated load capacity, and the remaining loadable capacity of the dump truck DT are displayed. This allows the operator on board the excavator 100 to load earth and sand onto the dump truck DT by working with reference to these displays.

As described above, the embodiments and the like of the excavator 100 have been described; note that the present inventive concept is not limited to the embodiments and the like described above, and various modifications and improvements can be made within the scope of the subject matter of the present inventive concept as set forth in the claims.

Although the description assumes that the load weight calculating part 61 calculates the weight of the earth and sand, based on the pressure of the bucket cylinder 9 (the boom cylinder 7 and the arm cylinder 8), the method of calculating the weight of earth and sand is not limited as such. The load weight calculating part 61 may calculate the weight of the earth and sand, based on the revolution torque when revolving the revolving upper body 3.

The case in which the load weight calculating part 61 calculates the weight of the earth and sand, based on the revolution torque when revolving the revolving upper body 3 will be described. The equation of motion of the revolution torque τ when revolving the revolving upper body 3 can be expressed by the following formula (12): Note that the attachment angle θ includes the boom angle, the arm angle, and the bucket angle.

J(θ)\ddot{ω}+h(θ,\dot{θ},\ddot{ω})\dot{ω}=τ (12)

where

ω: revolution angle

θ: attachment angle

J(θ): term considering inertia

h(θ, \dot{θ}): term considering Coriolis force and centrifugal force

τ: revolution torque

Also, the equation of motion of the revolution torque τ0 when revolving the revolving upper body 3 in the case where there is no earth and sand in the bucket 6 (in the case of empty load) can be expressed by the following formula (13):

J₀(θ)\ddot{ω}+h₀(θ,\dot{θ},\dot{ω}))\dot{ω}=τ₀ (13)

Also, the equation of motion of the revolution torque τw when revolving the revolving upper body 3 in the case where there is earth and sand in the bucket 6 can be expressed by the following formula (14):

(J₀(θ)+J_{w}(θ,M))\ddot{ω}+(h₀(θ,\dot{θ},\dot{ω})+h_{w}(θ,\dot{θ},\dot{ω},M))+\dot{ω}=τ_{w} (14)

where

J_{w}(θ, M), h_{w}(θ, \dot{θ}, \dot{ω}, M): increment by loaded matter

M: weight of loaded matter

Here, from formulas (13) and (14), difference Δτ between the revolution torque τw with earth and sand and the revolution torque τ0 without earth and sand can be expressed by the following formula (15):

Δτ=τ_{w}−τ₀=J_{w}(θ,M)\ddot{ω}+h_{w}(θ,\dot{θ},\dot{ω},M)\dot{ω} (15)

Here, the parameters other than load weight M in formula (15) are known or measurable; therefore, it is possible to calculate the load weight M.

In other words, the load weight calculating part 61 obtains the revolution driving force of the revolving upper body 3 in a revolution operation of the revolving upper body 3. Here, the revolution driving force of the revolving upper body 3 can be obtained from difference in pressure between one port and the other port of the hydraulic motor for revolution 2A, in other words, difference in hydraulic pressure detected in the hydraulic sensors 21 and 22.

Also, the load weight calculating part 61 obtains the position of the attachment by the position sensor. For example, the attachment angles (the boom angle, the arm angle, and the bucket angle) are obtained by the boom angle sensor S1, the arm angle sensor S2, and the bucket angle sensor S3. Also, the tilt angle of the machine body may be obtained by the machine tilt sensor S4. Also, the load weight calculating part 61 obtains the angular velocity of revolution and the revolution angle of the revolving upper body 3 by the revolution state sensor S5.

Also, the load weight calculating part 61 is provided with a table in advance. In the table, the load weight M is associated with the position of the attachment and the revolution driving force.

In this way, the load weight calculating part 61 can calculate the load weight M, based on the revolution driving force, the information from the position sensor, and the table.

Alternatively, the load weight calculating part 61 may determine the revolution inertia by the revolution driving force, to calculate the load weight M based on the determined revolution inertia.

Here, in the case of no earth and sand in the bucket 6, the revolution inertia can be determined from the position of the attachment and the known information (the position of the center of gravity, the weight, and the like of each part). Also, in the case where earth and sand is loaded in the bucket 6, the revolution inertia can be calculated from the revolution torque.

The increase in the revolution inertia from the case of no earth and sand to the case of presence of earth and sand is based on the weight of the earth and sand in the bucket 6. Therefore, the load weight M can be calculated by comparing the revolution inertia in the case of no earth and sand with the revolution inertia in the case of presence of earth and sand. In other words, the load weight M can calculated based on the difference between these revolution inertias.

Here, the position of the center of gravity of the earth and sand is included in the terms Jw and hw in formula (14). By calculating the position of the center of gravity of the earth and sand by the center of gravity of load calculating part 65, even in the case of calculating the load weight M by using the revolution torque of the revolving upper body 3, the precision of calculation can also be improved.

Also, the revolution driving force includes the effects of the moment of inertia and the centrifugal force caused by revolution. Therefore, the calculation method of the weight of the earth and sand in the load weight calculating part 61 can directly obtain the load weight M, without requiring any complicated compensation when calculating the weight of the loaded matter.

Note that an example has been described for the case where the excavator 100 revolves the revolving upper body 3, it is not limited as such. For example, in the case where the attachment has a velocity component in a direction other than the revolution direction when the revolving upper body 3 is revolving, the load weight M may be determined by taking the velocity of the attachment into account. For example, in the case where the bucket 6 moves in a direction further or closer with respect to the axis of rotation of the revolving upper body 3, or the bucket 6 moves in a direction upward or downward along the axis of rotation of the revolving upper body 3, the load weight M may be determined by taking the velocity of the bucket 6 into account.

### Example of Configuration of Main Screen

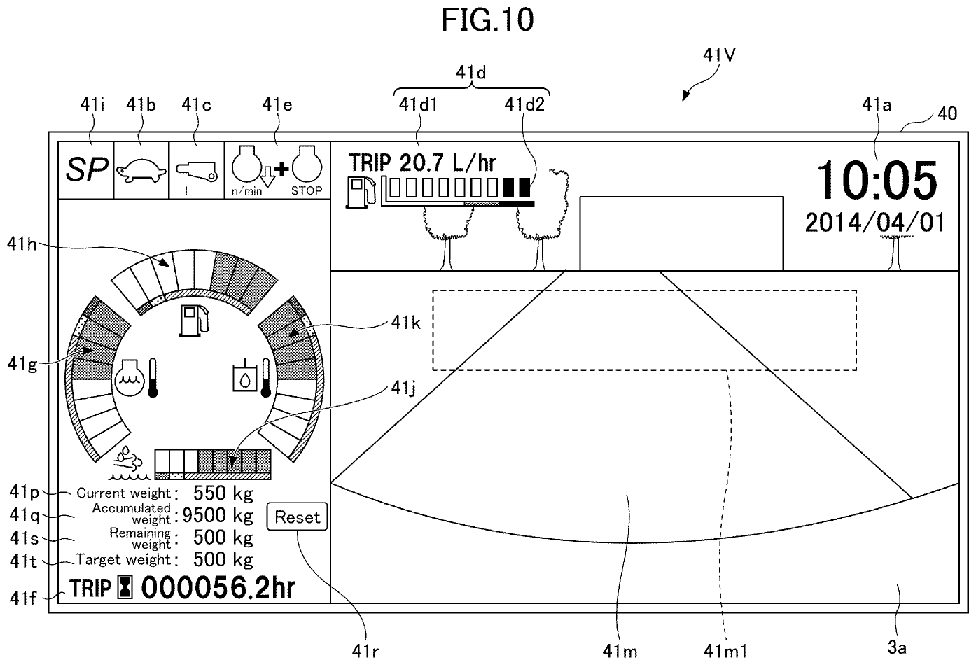

Next, with reference to FIG. 10, an example of a configuration of a main screen 41V displayed on the display device 40 will be described. The main screen 41V in FIG. 10 is displayed on the image display part 41.

A main screen 41V includes a date and time display area 41a, a traveling mode display area 41b, an attachment display area 41c, a fuel efficiency display area 41d, an engine control state display area 41e, an engine working hours display area 41f, a cooling water temperature display area 41g, a remaining fuel display area 41h, a revolutions per minute display area 41i, a remaining urea water display area 41j, a hydraulic oil temperature display area 41k, a camera image display area 41m, a current weight display area 41p, an accumulated weight display area 41q, a reset button 41r, a remaining loadable weight display area 41s, and a target weight display area 41t.

The traveling mode display area 41b, the attachment display area 41c, the engine control state display area 41e, and the revolutions per minute display area 41i are areas that display setting state information as information on the setting states of the excavator 100. The fuel efficiency display area 41d, the engine working hours display area 41f, the cooling water temperature display area 41g, the remaining fuel display area 41h, the remaining urea water display area 41j, the hydraulic oil temperature display area 41k, the current weight display area 41p, and the accumulated weight display area 41q are areas to display operational state information as information on the operational states of the excavator 100.

Specifically, the date and time display area 41a is an area to display the current date and time. The traveling mode display area 41b is an area to display the current traveling mode. The attachment display area 41c is an area to display an image representing the end attachment currently attached. FIG. 10 illustrates a state of displaying an image representing the bucket 6.

The fuel efficiency display area 41d is an area to display information on fuel efficiency calculated by the controller 30. The fuel efficiency display area 41d includes an average fuel efficiency display area 41d1 to display the lifetime average fuel efficiency or the interval average fuel efficiency, and an instantaneous fuel efficiency display area 41d2 to display the instantaneous fuel efficiency.

The engine control state display area 41e is an area to display the control state of the engine 11. The engine working hours display area 41f is an area to display the cumulative operating hours of the engine 11. The cooling water temperature display area 41g is an area to display the current temperature state of the engine cooling water. The remaining fuel display area 41h is an area to display the state of the remaining amount of fuel stored in the fuel tank. The revolutions per minute display area 41i is an area to display the current mode of revolutions per minute set by an engine revolutions per minute adjustment dial 75. The remaining urea water display area 41j is an area to display the remaining state of urea water stored in the urea water tank. The hydraulic oil temperature display area 41k is an area to display the temperature state of hydraulic oil in the hydraulic oil tank.

The camera image display area 41m is an area to display an image captured by the imaging device S6. In the example in FIG. 10, the camera image display area 41m illustrates a back camera image captured by the back camera 80B. The back camera image is a back image that shows the space behind the excavator 100, and includes a counterweight image 3a.

The current weight display area 41p is an area to display the weight (current weight) of an object actually lifted by the bucket 6. FIG. 10 illustrates that the current weight is 550 kg.

The controller 30 calculates the current weight, for example, based on the position of the work attachment, the boom bottom pressure, and specifications of the work attachment registered in advance (the weight, the position of the center of gravity, etc.). Specifically, the controller 30 calculates the current weight based on the outputs of information obtaining devices such as the boom angle sensor S1, the arm angle sensor S2, the boom bottom pressure sensor S7B, and the like.

The accumulated weight display area 41q is an area to display the accumulated weight of objects lifted by the bucket 6 for a predetermined period of time (referred to as the “accumulated weight”, hereafter). FIG. 10 illustrates that the accumulated weight is 9,500 kg.

The predetermined period of time is, for example, a period started when the reset button 41r was pressed. For example, when performing work of loading earth and sand onto the bed of the dump truck DT, the operator resets the accumulated weight of the dump truck DT by pressing the reset button 41r every time the dump truck DT to be loaded is replaced. This is to easily grasp the total weight of the earth and sand loaded in each dump truck DT.

With this configuration, the excavator 100 can prevent earth and sand that exceeds the maximum loadable weight of the dump truck DT, from being loaded on the bed of the dump truck DT. If weight measurement on a truck scale detects that loading of earth and sand exceeds the maximum loadable weight, the driver of the dump truck DT needs to return to the loading yard, and unload part of the earth and sand loaded on the bed. The excavator 100 can prevent occurrence of such adjustment work of the load weight.

The predetermined period of time may be, for example, a period of time from the time to start the work of a day until the time to end the work of the day. This is to make the total weight of the earth and sand transported by the work of the day easily recognizable by the operator or manager.

The reset button 41r is a software button to reset the accumulated weight. The reset button 41r may be a hardware button arranged on the input device 42, the left operation lever 26L, the right operation lever 26R, or the like.

The controller 30 may be configured to automatically recognize replacement of the dump truck DT, and may automatically reset the accumulated weight. In this case, the controller 30 may use an image captured by the imaging device S6 to recognize the replacement of the dump truck DT, or may use a communication device to recognize the replacement of the dump truck DT.

Also, the controller 30 may be configured to accumulate the current weight, after recognizing that the earth and sand lifted by the bucket 6 has been loaded onto the bed of the dump truck DT, based on an image captured by the imaging device S6. This is to prevent earth and sand moved to a place other than the bed of the dump truck DT from being accumulated as the earth and sand loaded onto the dump truck DT.

The controller 30 may determine whether the earth and sand lifted in the bucket 6 has been loaded onto the bed of the dump truck DT, based on the position of the work attachment. Specifically, the controller 30 may determine that earth and sand are loaded onto the bed of the dump truck DT, for example, in the case where the height of the bucket 6 exceeds a predetermined value (e.g., the height of the bed of the dump truck DT) and a release button 65C is pressed.

The controller 30 may be configured to output a warning if it is determined that the current weight exceeds a predetermined value. The predetermined value is, for example, a value based on the rated lift weight. The warning may be a visual warning, an auditory warning, or a tactile warning. With this configuration, the controller 30 can inform the operator that the current weight exceeds or is likely to exceed the predetermined value.

The remaining loadable weight display area 41s is an area to display the remaining loadable weight. FIG. 10 illustrates that the accumulated weight is 9,500 kg, and the remaining loadable weight is 500 kg. In other words, the maximum loadable capacity is 10,000 kg. However, the display device 40 may display the maximum loadable capacity without displaying the remaining loadable weight, or may display the maximum loadable capacity separately from the remaining loadable weight.

The target weight display area 41t is an area to display the target weight of an object attracted by the bucket 6. Note that the target weight is set to a value that does not exceed the remaining loadable weight.

In the example illustrated in FIG. 10, as the remaining loadable weight is 500 kg, the target weight is set to 500 kg. In contrast, the current weight is 550 kg. Therefore, the controller 30 controls reducing the current of the bucket 6 until the current weight becomes 500 kg (target weight). This can prevent overload on the dump truck DT.

As described above, according to the excavator 100 in the present embodiment, the weight (current weight) of an object lifted by the bucket 6 can be set as the target weight.

Note that one might consider a configuration that includes a table in which a target weight is associated with a target current command, so that a desired target current command to supply a current to the bucket 6 is generated based on the associated target weight, and by the generated command, the weight of the object lifted by the bucket 6 is controlled to be closer to the target weight. However, in the case where the object to be attracted by the bucket 6 is an object that has variation in density, such as earth and sand or iron frames, even if a current value corresponding to the target weight is applied, it is expected that the weight of the object actually attracted by the bucket 6 deviates from the target weight. In contrast, according to the excavator 100 according to the present embodiment, the weight of the object raised by the bucket 6 can be set as the target weight.

Also, a message is displayed on the message display area 41m1. For example, if the current weight exceeds the target weight, a message conveying the overload is displayed. This can prevent a loading operation that would be performed before completion of the weight adjustment. Also, a message may also be displayed if the accumulated weight exceeds the maximum loadable capacity. With this message, it is possible to urge the operator to perform an unloading operation, and thereby, can prevent overload of the dump truck DT.

### [Loading Support System]

Next, the loading support system SYS will be described with reference to FIG. 11. FIG. 11 is a diagram illustrating an example of a configuration of a loading support system SYS. The loading support system SYS is constituted with an excavator 100, a mobile body 200 including a support device 210 provided in a dump truck DT, a management device 300, and a support device 400; and may be configured to be communicable via a communication network 900.

The support device 210 is a portable terminal device, for example, a computer such as a notebook PC, tablet PC, smartphone, or the like set up in the dump truck DT.

The management device 300 is a fixed terminal device, for example, a server computer installed in a management center or the like outside a work site. Note that the management device 300 can be a portable computer (e.g., a portable terminal device such as a notebook PC, tablet PC, or smartphone).

The support device 400 is a portable terminal device, such as a notebook PC, a tablet PC, or a smartphone carried by the operator or the like present on a work site.

The controller 30 of the excavator 100 may transmit the calculated weight of the earth and sand to the management device 300 via the communication device T1 and the communication network 900. In this way, the management device 300 can control the weight of the loaded matter such as earth and sand loaded in the dump truck DT by the excavator 100. Also, the controller 30 of the excavator 100 may transmit the calculated weight to the support device 210 provided on the dump truck DT via the communication device T1 and the communication network 900.

Also, the excavator 100 may be remotely operated via the communication network 900.

As above, the embodiments and the like of the excavator 100 have been described; note that the present inventive concept is not limited to the embodiments and the like described above, and various modifications and improvements can be made within the scope of the subject matter of the present inventive concept as set forth in the claims.

1. An excavator comprising:
an attachment attached to a revolving upper body; and
a first actuator and a second actuator configured to drive the attachment; and
a control device including a memory and a processor configured to execute
calculating a weight of a loaded matter loaded in the attachment as a first weight, based on the first actuator, and
calculating a weight of the loaded matter as a second weight, based on the second actuator.

2. The excavator as claimed in claim 1, wherein the processor is further configured to execute switching between the calculating of the first weight and the calculating of the second weight.

3. The excavator as claimed in claim 2, wherein the processor executes the switching by selecting a weight from among the first weight calculated in the calculating of the first weight and the second weight calculated in the calculating of the second weight.

4. The excavator as claimed in claim 2, wherein the processor executes the switching by switching a weight calculating process of the weight of the loaded matter, from among a process executed in the calculating of the first weight and a process executed in the calculating of the second weight.

5. The excavator as claimed in claim 2, wherein the attachment is provided with a boom, an arm, and a bucket,
wherein the first actuator drives the boom, and
wherein the second actuator drives the bucket or the arm.

6. The excavator as claimed in claim 5, wherein the processor executes the switching by adopting the second weight as the weight of the loaded matter, when the first actuator executes an operation of raising the boom.

7. The excavator as claimed in claim 1, wherein the processor is further configured to execute calculating a center of gravity of the loaded matter.

8. An excavator comprising:
an attachment attached to a revolving upper body, and including a bucket;
a bucket cylinder configured to drive the bucket; and
a control device including a memory and a processor configured to execute calculating a weight of a loaded matter loaded on the bucket, based on the bucket cylinder.

9. The excavator as claimed in claim 8, wherein the processor is further configured to execute calculating a center of gravity of the loaded matter loaded on the bucket.

10. The excavator as claimed in claim 9, further comprising:
an imaging device configured to capture an image of the loaded matter,
wherein the processor executes the calculating of the center of gravity of the loaded matter, based on a shape of the loaded matter in the image captured by the imaging device.

11. The excavator as claimed in claim 9, wherein the processor executes the calculating of the center of gravity of the loaded matter, based on at least one of a type and a state of the loaded matter.

12. The excavator as claimed in claim 9, wherein the processor executes the calculating of the center of gravity of the loaded matter, based on pressure of the bucket cylinder when the bucket is set to a first state, and pressure of the bucket cylinder when the bucket is set to a second state in which a bucket angle is different from that in the first state.

13. The excavator as claimed in claim 9, wherein the attachment further includes
a boom and an arm,
a boom cylinder configured to drive the boom, and
an arm cylinder configured to drive the arm,
wherein the processor executes the calculating of the center of gravity of the loaded matter, based on at least two of pressure of the boom cylinder, pressure of the arm cylinder, and the pressure of the bucket cylinder.
